(19) United States
(12) Patent Application Publication
(10) Pub. No.: US 2008/0270189 A1
(43) Pub. Date: Oct. 30, 2008

(54) HEALTH CARE PRACTICE MANAGEMENT MESSAGING AND MINING SYSTEM AND METHOD

(75) Inventor: Ryan Howard, San Francisco, CA (US)

Correspondence Address: DAVIS WRIGHT TREMAINE, LLP/Seattle, 1201 Third Avenue, Suite 2200, SEATTLE, WA, 98101-3045, US

(73) Assignee: PRACTICE FUSION, INC., San Francisco, CA (US)

(21) Appl. No.: 11/944,356

(22) Filed: Nov. 21, 2007

Related U.S. Application Data
(60) Provisional application No. 60/866,806, filed on Nov. 21, 2006.

(51) Int. Cl. G06Q 30/00; G06Q 10/00; G06Q 50/00

(52) U.S. Cl. 705/3; 705/14

(57) ABSTRACT

A health care practice management system is used to store, update and access data regarding patients of practitioners such as doctors and staff. The health care practice management system provides access to collections of data for research by data miners based on such aspects as type of patient condition, patient class, or type of patient treatment. The health care practice management system also provides a vehicle to message targeted groups of individuals, namely, practitioners, patients, and miners of the practice data. The health care practice management system can be distributed to users through a reduced cost arrangement that is support through contributions from third parties by sponsoring messages to be displayed through the system to users.

### CROSS REFERENCE TO RELATED APPLICATION

This application claims priority benefit of provisional application Ser. No. 60/866,806 filed Nov. 11, 2006, the content of which is incorporated in its entirety.

### FIELD OF THE INVENTION

The present invention is directed generally to health care practice management systems.

### BACKGROUND

Regardless of the type of practice that a physician or other health care practitioner or other health care personnel has, the practitioner and other health care personnel have need to query and update practice data and perform other practice management functions. Practitioners can include, but are not limited to, primary, referring or consulting physicians. The practitioners can be associated as physicians or support staff of such organizations as physician practices and clinics, hospitals and healthcare groups such as managed care organizations, insurance providers, managed service organizations, physician hospital organizations, independent physician associations, physician practice management companies and billing services.

Practice data can include such aspects as scheduling information, patient health history, status, and treatment information, and billing, insurance and other financial information. Practice data is generally stored and accessed electronically and is viewed through use of computer monitors by practitioners and others.

### BRIEF DESCRIPTION OF THE SEVERAL VIEWS OF THE DRAWING(S)

FIG. 1 is a schematic diagram of an exemplary implementation of a computer environment that can be used with the present invention related to a practice management messaging and mining system and method.

FIG. 2 is a block diagram of a health care practice management system.

FIG. 3 is a block diagram of a health care practice management platform as part of the health care practice management system.

FIG. 4 is an interaction diagram involving communication between a practitioner communication device, the health care practice management platform, and a content data provider of the health care practice management system.

FIG. 5 is an interaction diagram involving communication between a patient communication device, the health care practice management platform, and the content data provider of the health care practice management system.

FIG. 6 is an interaction diagram involving communication between a data miner communication device, the health care practice management platform, and the content data provider of the health care practice management system.

FIG. 7 is a flow chart depicting a first method of the health care practice management system.

FIG. 8 is a flowchart depicting a second method of the health care practice management system.

FIG. 8A is a flowchart depicting a third method of the health care practice management system.

FIG. 9 is a schematic depiction of a first exemplary screenshot presentation of the health care practice management system.

FIG. 10 is a schematic depiction of a second exemplary screenshot presentation of the health care practice management system.

FIG. 11 is a schematic depiction of a third exemplary screenshot presentation of the health care practice management system.

FIG. 12 is a schematic depiction of a fourth exemplary screenshot presentation of the health care practice management system.

FIG. 13 is a schematic depiction of a fifth exemplary screenshot presentation of the health care practice management system.

FIG. 14 is a schematic depiction of a sixth exemplary screenshot presentation of the health care practice management system.

FIG. 15 is a schematic depiction of a seventh exemplary screenshot presentation of the health care practice management system.

FIG. 16 is a schematic depiction of an eighth exemplary screenshot presentation of the health care practice management system.

FIG. 17 is a schematic depiction of a ninth exemplary screenshot presentation of the health care practice management system.

FIG. 18 is a schematic depiction of a tenth exemplary screenshot presentation of the health care practice management system.

FIG. 19 is a schematic depiction of an eleventh exemplary screenshot presentation of the health care practice management system.

FIG. 20 is a schematic depiction of a twelfth exemplary screenshot presentation of the health care practice management system.

FIG. 21 is a schematic depiction of a thirteenth exemplary screenshot presentation of the health care practice management system.

FIG. 22 is a schematic depiction of a fourteenth exemplary screenshot presentation of the health care practice management system.

FIG. 23 is a schematic depiction of a fifteenth exemplary screenshot presentation of the health care practice management system.

FIG. 24 is a schematic depiction of a sixteenth exemplary screenshot presentation of the health care practice management system.

FIG. 25 is a schematic depiction of a seventeenth exemplary screenshot presentation of the health care practice management system.

FIG. 26 is a schematic depiction of a eighteenth exemplary screenshot presentation of the health care practice management system.

FIG. 27 is a schematic depiction of a nineteenth exemplary screenshot presentation of the health care practice management system.

FIG. 28 is a schematic depiction of a twentieth exemplary screenshot presentation of the health care practice management system.

FIG. 29 is a schematic depiction of a twenty-first exemplary screenshot presentation of the health care practice management system.

FIG. 30 is a schematic depiction of a twenty-second exemplary screenshot presentation of the health care practice management system.

FIG. 31 is a schematic depiction of a twenty-third exemplary screenshot presentation of the health care practice management system.

FIG. 32 is a schematic depiction of a twenty-fourth exemplary screenshot presentation of the health care practice management system.

FIG. 33 is a schematic depiction of a twenty-fifth exemplary screenshot presentation of the health care practice management system.

FIG. 34 is a schematic depiction of a twenty-sixth exemplary screenshot presentation of the health care practice management system.

FIG. 351 is a schematic depiction of a twenty-seventh exemplary screenshot presentation of the health care practice management system.

FIG. 36 is a schematic depiction of a twenty-eighth exemplary screenshot presentation of the health care practice management system.

FIG. 37 is a schematic depiction of a twenty-ninth exemplary screenshot presentation of the health care practice management system.

FIG. 38 is a schematic depiction of a thirtieth exemplary screenshot presentation of the health care practice management system.

FIG. 39 is a schematic depiction of a thirty-first exemplary screenshot presentation of the health care practice management system.

FIG. 40 is a schematic depiction of a thirty-second exemplary screenshot presentation of the health care practice management system.

FIG. 41 is a schematic depiction of a thirty-third exemplary screenshot presentation of the health care practice management system.

FIG. 42 is a schematic depiction of a thirty-fourth exemplary screenshot presentation of the health care practice management system.

FIG. 43 is a schematic depiction of a thirty-fifth exemplary screenshot presentation of the health care practice management system.

### DETAILED DESCRIPTION OF THE INVENTION

As disclosed herein, a health care practice management system is used to store, update and access data regarding patients of practitioners such as doctors. The health care practice management system provides access to collections of data for research by data miners based on such aspects as type of patient condition, patient class, or type of patient treatment. The health care practice management system also provides a vehicle to message targeted groups of individuals, namely, practitioners, patients, and miners of the practice data.

The health care practice management system can provide integrated, community-based healthcare solutions enabling physicians to run their practices, facilitate the revenue cycle, and share patient records across a practitioner community. The practice data can include patient's visits, treatment, prescriptions, medical records, clinical analysis for diseases and pharmaceuticals, physician revenue, productivity, performance, utilization and fraud, reimbursement performance and outstanding claims revenue.

The health care practice management system can be distributed to practitioners through a web access with little or no software or hardware to distribute to the practitioners that have basic computers. The distribution of the health care practice management system to practitioners can also be at no cost or at an aggressively reduced cost to the practitioners and practitioner based organizations to facilitate establishment of a community of practitioner users of the health care practice management system. The health care practice management system can facilitate marketing opportunities to the practitioner community through pay per click advertising from such entities as pharmaceutical and heath plan companies. This type of advertising can offer direct messaging to practitioners at the time and point of care regarding latest research, public service updates, CDC announcements, and also revenue generating product promotion.

The community also allows for cumulating data to be able to sell aggregated, real-time and/or historical point of care data. The data can include diseases, chronic conditions (such as hypertension, diabetes, congestive heart failure, asthma, depression, obesity), medication types, brand name vs. generic comparisons, dosage levels, fill dates, refill labs, payer performance (such as by health plan) including approvals, denials, adjustments, and pay for performance. The data can be sold to such entities as pharmaceutical companies, health plan companies, clinical research groups, government agencies (such as CDC, Homeland Security, CMS Sales Strategy). Information and advertising can be obtained from a content provider such as yahoo or google. Patient data such as involving allergies, current conditions, and past history can be used as keywords to be sent to a content provider. Based upon the keywords, the content provider can then send through the health care practice management system to the practitioner information and advertising related to the keywords. Other keywords can be based upon industry standard codes used to classify insurance reimbursement claims submitted by the practitioners to insurance companies.

At least some of the industry standard codes are published by the American Medical Association so are well recognized by the practitioners. For instance, diagnoses can be characterized by ICD-9 codes according to the International Classification of Diseases, 9th Revision, Clinical Modification, which lists diagnoses and identifying codes used by physicians for reporting diagnoses of health plan enrollees. Treatments can be classified by CPT (Current Procedural Terminology) or HCPCS codes (Healthcare Common Procedure Coding System). These codes describe the type of services that are being supplied to the patient.

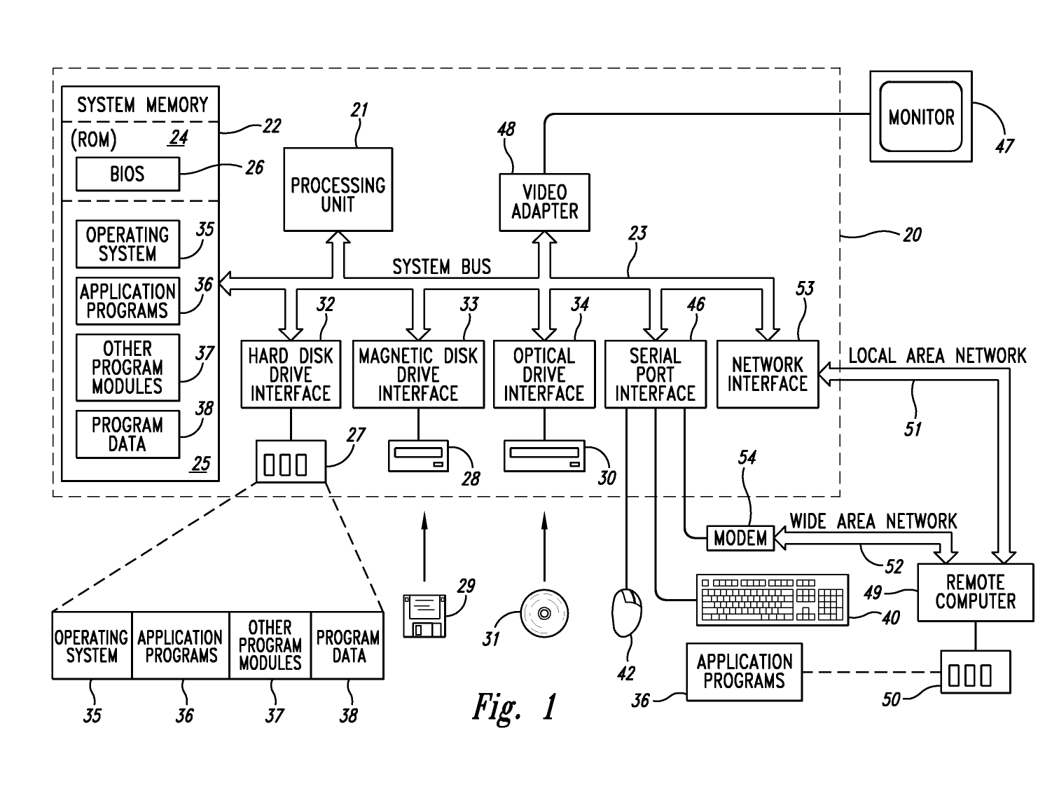

An exemplary hardware and operating environment of FIG. 1 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20, the local computer; implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

The hardware and operating environment in conjunction with implementations that may be practiced has been described. The computer in conjunction with implementation that may be practiced may be a conventional computer, a distributed computer, or any other type of computer. Such a computer typically includes one or more processing units as its processor, and a computer-readable medium such as a memory. The computer may also include a communications device such as a network adapter or a modem, so that it is able to communicatively couple to other computers.

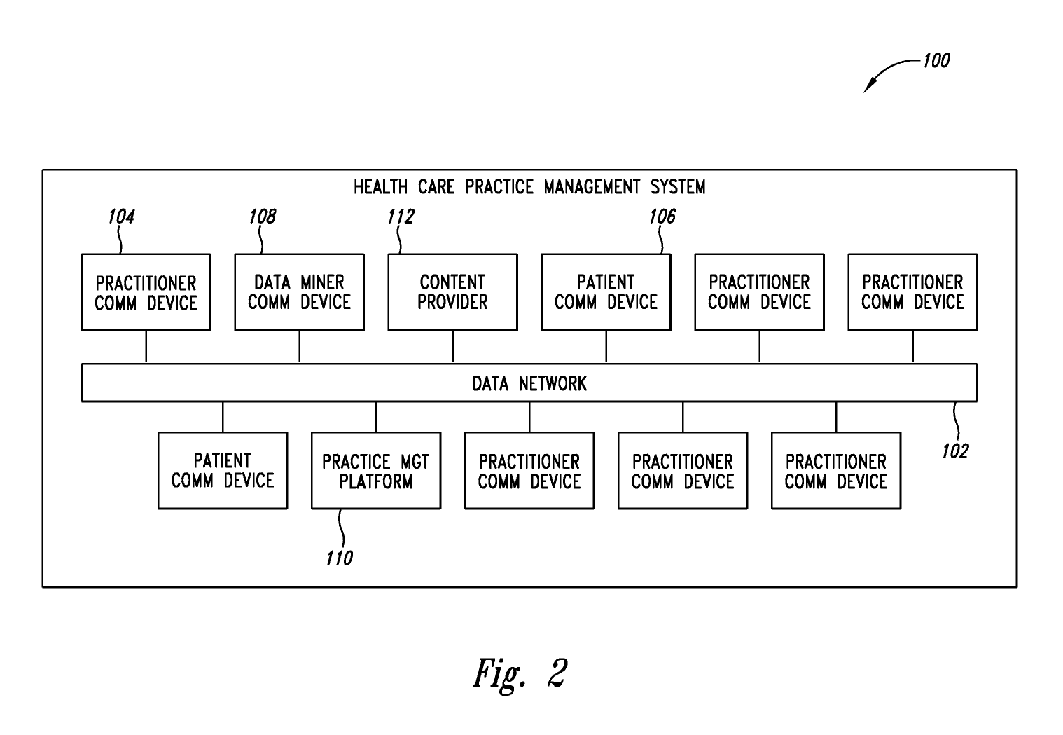

A health care practice management system 100 is shown in FIG. 2 as having a data network, 102 such as the internet, a cellular system, or other such network, communicatively linking practitioner communication devices 104, patient communication devices 106, and data miner communication devices 108 to a health care practice management platform 110, all included in the health care practice management system. The health care practice management system 100 also has a content provider 112 that is communicatively linked by the data network 102 to the health care practice management platform 110.

The practitioner communication devices 102, the patient communication devices 106, and the data miner communication devices 108 can be a computer workstation with a web browser, or other such communication device such as a mobile, portable and/or wireless computer, personal data assistant, cellular device, etc. or hardware—software configuration. In alternative implementations various of the components such as the data network 102, the practitioner communication device 104, the health care practice management platform 110, and the content provider 112 could reside on a common hardware—software system.

The practitioner communication devices 104, the patient communication devices 106, and the data miner communication devices 108 can differ as far as access and operational privileges for the health care practice management platform 110. For instance, the practitioner communication device 104 in some instances could be able to set appointments, input prescriptions, health status or other such information whereas some instances of the patient communication devices 106 and the data miner communication devices 108 may only have a read ability of a fewer number of pages and tasks from the health care practice management platform 110.

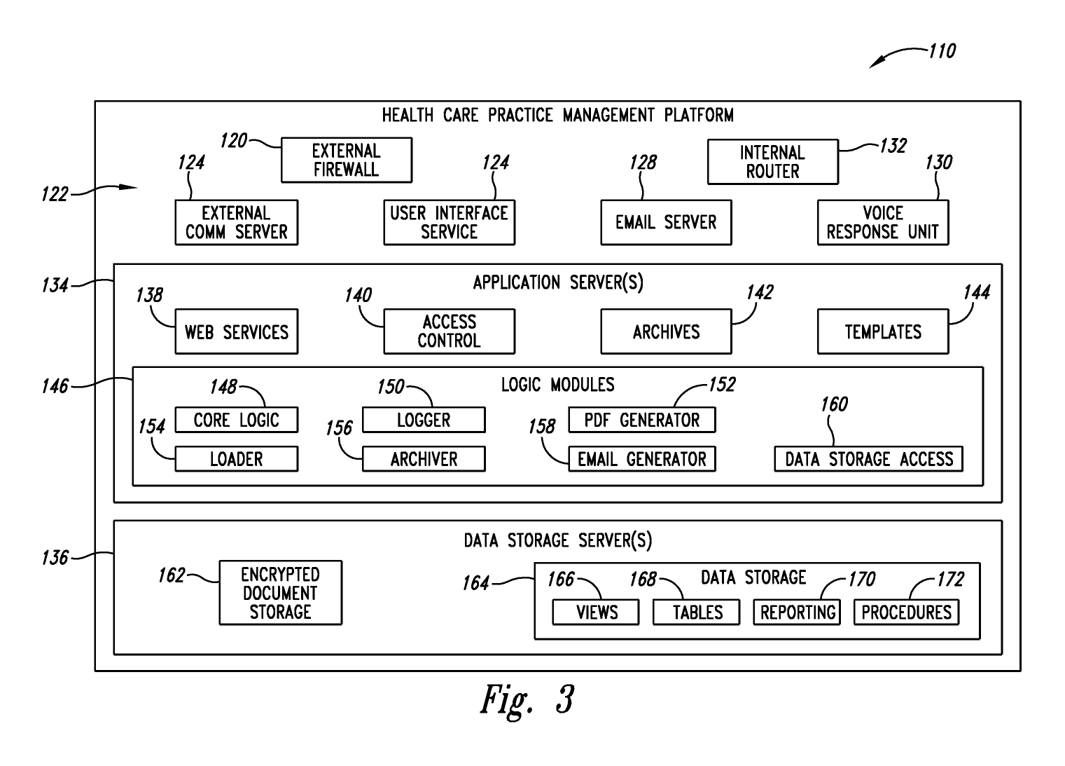

Further detail of the health care practice management platform 110 is shown in FIG. 3 as having an external firewall 120 protecting access to the other components of the health care practice management platform. On a first layer 122 nearest the external firewall 120, components of the health care practice management platform 110 include an external communication server 124, a user interface service 126, an e-mail server 128, and a voice response unit 130. In some instances the external communication server 124 provides such communication facility as HL7 communication, HL7 to XML processing, and HL7 and XML archiving and operation logging.

The user interface service 126 can include an external web service and a public web server such as using languages such as ASP.NET, Java, or other such languages. The e-mail server 128 provides an e-mail service to the practitioner communication devices 104, the patient communication devices 106, and/or the data miner communication devices 108 through such protocols as SMTP. The voice response unit 130 can provide such capability as found with Speech Server by Microsoft Corporation, Redmond, Wash.

The health care practice management platform 110 further includes an internal router 132 that can also serve as an internal firewall to control traffic to further components including one or more application servers 134 and one or more data storage servers 136. The application servers 134 can include web services 138, an access control 140, an archives 142, a templates 144, and logic modules 146. The web services 138 can provide services including web-based communication and presentations to the practitioner communication devices 104, the patient communication devices 106, and the data miner communication devices 108. The access control 140 can include session and token validation.

The archives 142 can include storage for HL7 and XML files. The templates 144 can include storage for PDF templates and e-mail templates. The logic modules 146 can include a core logic 148, a logger 150, a PDF generator 152, a loader 154, an archiver 156, an e-mail generator 158, and a data storage access 160. The core logic 148 can coordinate requests and responses between the web services 138 and the data storage servers 136. The logger 150 can log all application server operations and various calls between at least a portion of the components of the health care practice management platform 110.

The PDF generator 152 can generate PDF files to populate templates from the data storage servers 136. The loader 154 can load XML from the external communications server 124 to the data storage servers 136. The archiver 156 can transfer HL7 and XML files from the logic modules 146 to the archives 142. The email generator 158 can populate templates from the archives 142. The data storage access 160 can facilitate transfer of data between the application servers 134 and the data storage servers 136.

The data storage servers 136 can include an encrypted document storage 162 and data storage 164. The encrypted document storage 162 can be used by practitioners and other privileged users of the health care practice management platform 110 to store PDF and image files regarding practice data. The data storage 164 can include views 166, tables 168, reporting 170, and procedures 172. The reporting 170 can include SQL server reporting.

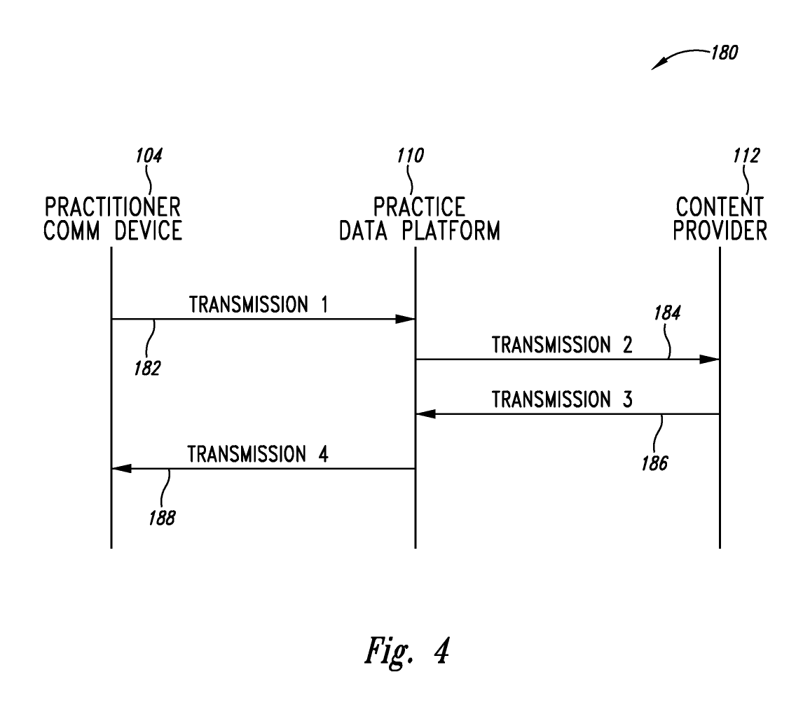

An interaction diagram 180 involving communication between the practitioner communication device 104, the health care practice management platform 110, and the content data provider 112 of the health care practice management system 110 is shown in FIG. 4. In a first transmission 182, the practitioner communication device 104 sends a data query, data addition, or data update to the health care practice management platform 110 containing a keyword and/or code. The health care practice management platform 110 then sends on the keyword and/or code in a second transmission 184 to the content provider 112.

The content provider 112 then sends information and/or an advertisement in a third transmission 186 to the health care practice management platform 110. The information and/or the advertisement is then sent from the health care practice management platform 110 in a fourth transmission 188. Transmissions can be web-based so that some of the transmissions, such as from the health care practice management platform 110 to the practitioner communication device 104 can be in the form of a web-page on the health care practice management platform 110 being viewed by a web browser, as part of the practitioner communication device.

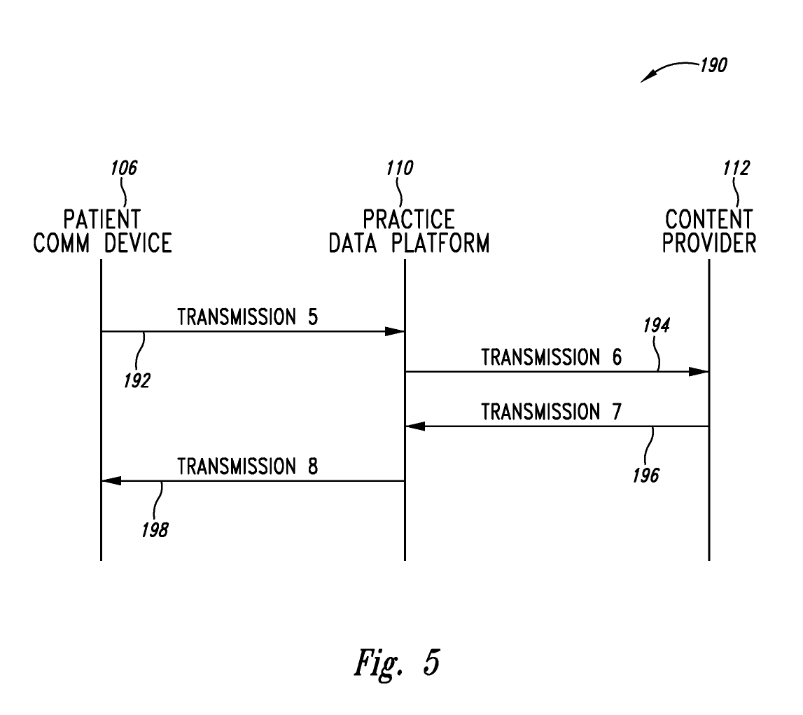

An interaction diagram 190 involving communication between the patient communication device 106, the health care practice management platform 110, and a content data provider 112 of the health care practice management system 100 is shown in FIG. 5. In a fifth transmission 192, a patient communication device 106 sends a data query, data addition, or data update to the health care practice management platform 110 containing a keyword and/or code. The health care practice management platform 110 then sends on the keyword and/or code in a sixth transmission 194 to the content provider 112.

The content provider 112 then sends information and/or an advertisement in a seventh transmission 196 to the health care practice management platform 110. The information and/or the advertisement is then sent from the health care practice management platform 110 in an eighth transmission 198. Transmissions can be web-based so that some of the transmissions, such as from the health care practice management platform 110 to the patient communication device 106 can be in the form of a web-page on the health care practice management platform 110 being viewed by a web browser, as part of the patient communication device 106.

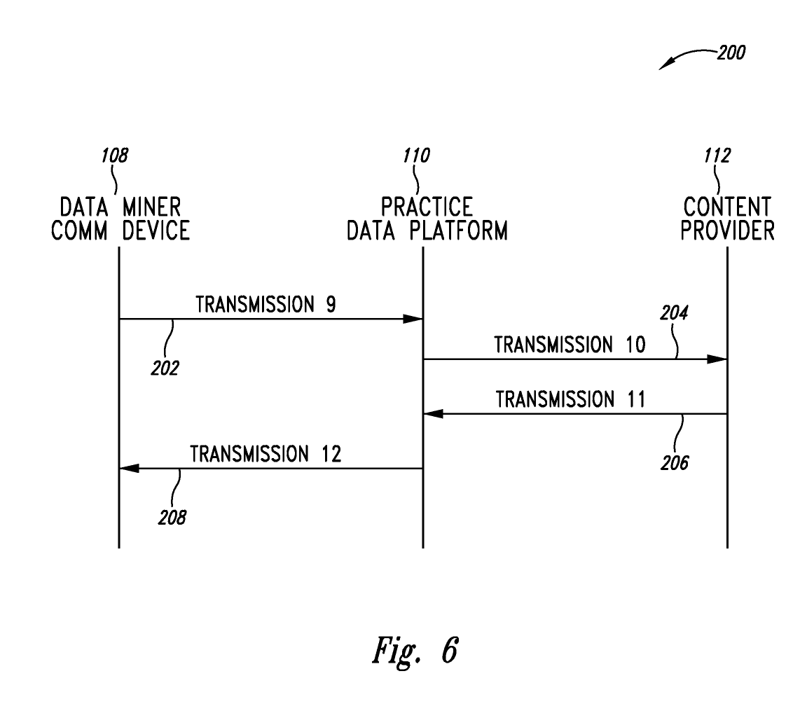

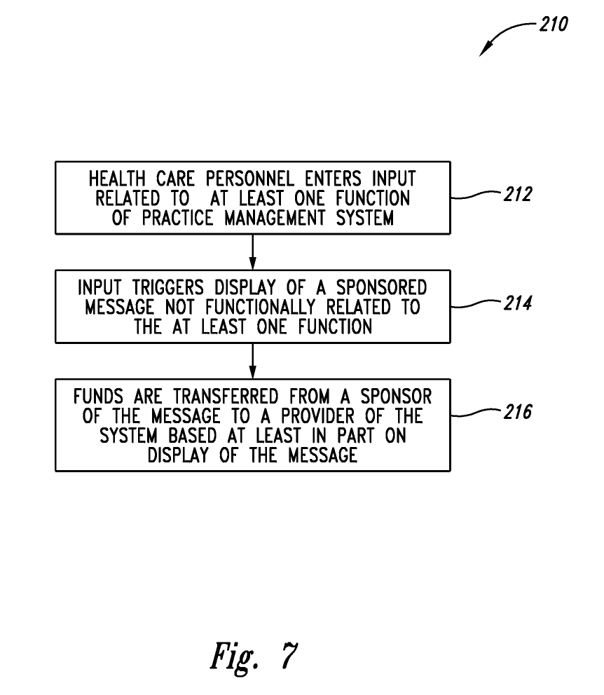

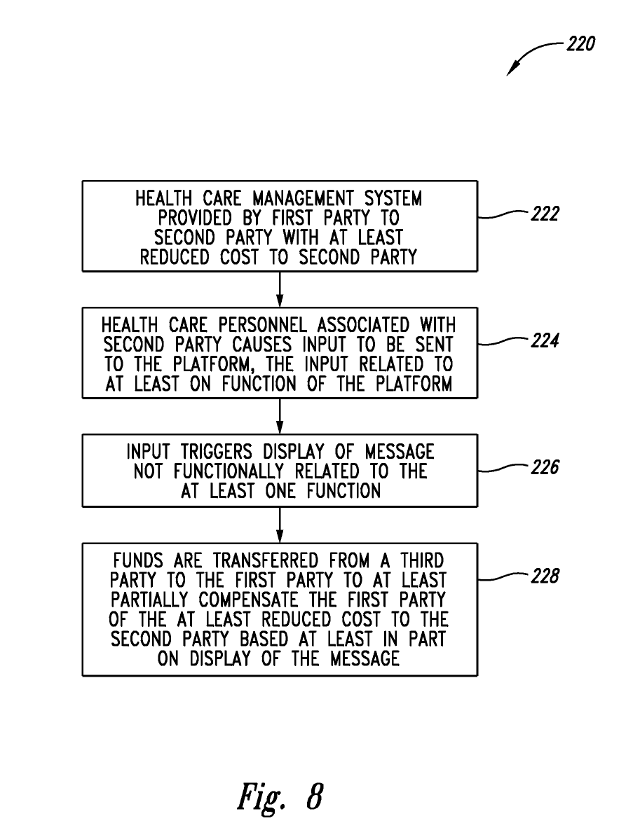

An interaction diagram 200 involving communication between the data miner communication device 108, the health care practice management platform 110, and a content data provider 112 of the health care practice management system 100 is shown in FIG. 6. In a ninth transmission 202, the data miner communication device 108 sends a data query to the health care practice management platform 110 containing a keyword and/or code. The health care practice management platform 110 then sends on the keyword and/or code in a tenth transmission 204 to the content provider 112.

The content provider 112 then sends information and/or an advertisement in an eleventh transmission 206 to the health care practice management platform 110. The information and/or the advertisement is then sent from the health care practice management platform 110 in a twelfth transmission 208. Transmissions can be web-based so that some of the transmissions, such as from the health care practice management platforms 110 to the data miner communication device 108 can be in the form of a web-page on the health care practice management platform being viewed by a web browser, as part of the data miner communication device.

A method 210 is depicted in FIG. 7 as including a health care personnel, such as a practitioner, staff, data miner, or other user entering input related to at least one function of the health care practice management system 100 (step 212). The at least one function could include aspects such as scheduling, billing, electronic medical recording/charting, prescription writing, laboratory ordering and results, diagnosis management, immunization management, and physician-to-physician messaging/e-mailing and other such functions.

The at least one function can be related to demographics and/or medical history, and/or diagnosis and medication summary, and/or medication detail, and/or summary of vital statistics, and/or pending appointments, and/or notes of visit, and/or schedule—select patient, and/or scheduled appointment of patient, and/or adding an appointment, and/or changing an appointment, and/or checking patient in and no-show and/or upload patient demographics, and/or documenting immunizations, and/or managing vaccine inventory, and/or list of notes in chart note editor, and/or text entry templates, and/or managing diagnosis, and/or diagnosis detail, and/or writing prescriptions, and/or faxing prescriptions, and/or documenting samples given, and/or refill request, and/or forward refill to other MD, and/or MDs personal refill bin, and/or patient check-out—finish with visit follow-up, and/or notify biller—finish with visit follow-up, and/or different sorts of messages, and/or general messages, and/or to do items.

Further examples of aspects related to the at least one function can include a user, such as a health care personnel, using the health care practice management system 100 to choose a schedule or a patient, to change a patient's status (such as “checked-in” or “no-show”), to redirect a display to a patient chart, to have patient demographics to be displayed, to choose a summaries tab, to cause a specific summary to be viewed, to add an immunization record or data, such as a particular vaccine, to choose a diagnostics and medications tab, to review and/or add a new diagnosis, to review and/or add and/or refill a new medication, to add an event, to choose a chart notes window, to choose a current chart window, to choose an objective window, to choose an assessment window, to choose a plan window, to click OK and cause to be redirected to a chart review, to sign a note, to choose a labs window, to view lab results, to choose a biller recipient, to code a chart, to enter a message and submit, and/or to message the front desk,

The method 210 includes the input from step 212 triggering display of at least one sponsored message that is not functionally related to the at least one function of step 212 (step 214). The at least one sponsored message can be triggered by a key word or some action taken related to the at least one function of step 212, but the at least one sponsored message is not used in some manner to assist with accomplishing the at least one function of step 212. As discussed to a certain degree above, the health care practice management system 100 is furnished by a first party for use by one or more practitioners and/or other health care personnel associated with a second party. The first and second parties could form any type of organization not limited to corporations and/or limited liability organizations, and/or non-profit organizations and/or individuals.

The health care practice management system 100 is furnished at no cost or at reduced cost to the second party by the first party. In order to re-coop costs, expenses, and/or profits that would otherwise be obtained from the second party by the first party, the first party arranges one or more other relationships with one or more third parties to at least partially sponsor the provision of the health care practice management system 100 by the first party for the second party.

Sponsorship of the health care practice management system 100 takes a form of payment from the one or more third parties to the first party for the at least one sponsored message as displayed in step 212. Payment for the at least one sponsored message can be by one or more of a number of arrangements, for instance, by way of example but not limited to a periodic subscription basis, a per click occurrence basis, a per message basis, and/or other arrangements. Accordingly, the method 200 includes funds being transferred from a sponsor of the message to a provider of the system based at least in part on display of the message.

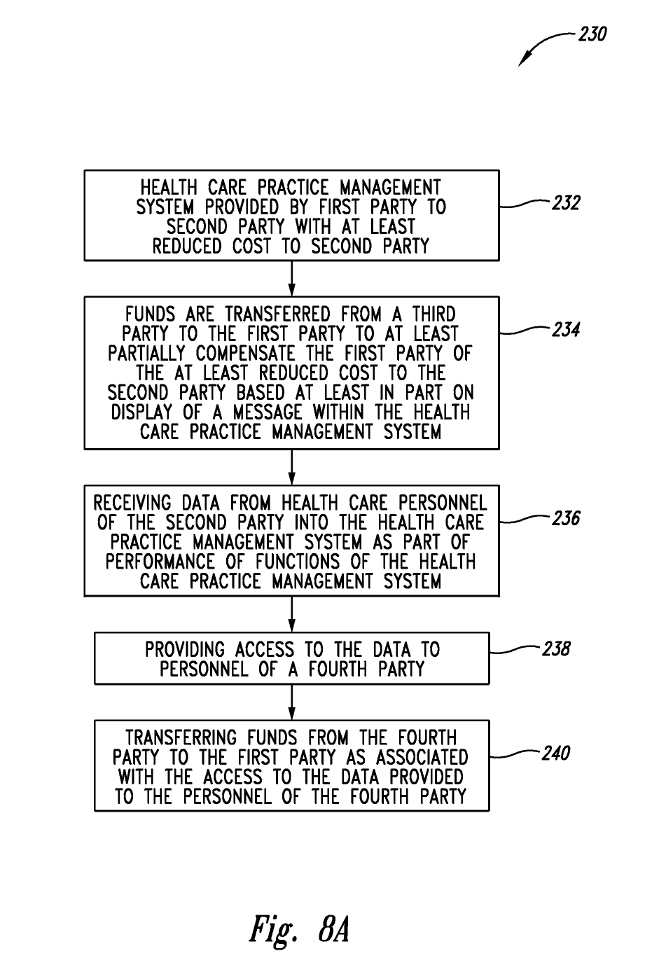

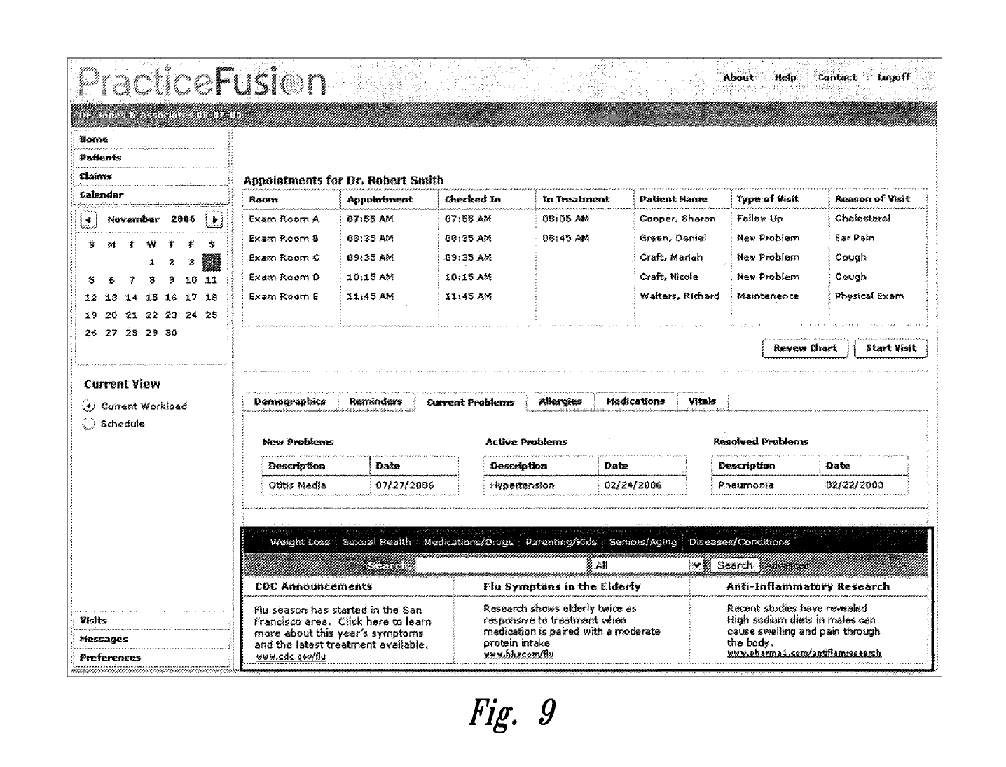

As an alternative, addition, and/or complement to the method 210, a method 220 is depicted in FIG. 8 as having the health care practice management system 100 be provided by a first party to a second party with at least reduced cost to the second party (step 222). The method 220 includes a health care personnel, such as a practitioner or staff person, associated with the second party causing input (such as by using the practitioner communication device 104) to be sent to the health care practice management platform 110 in which the input is related to at least one function of the platform (step 224).

The input from step 222 triggers display of a message, such as being displayed by the practitioner communication device 104, in which the message is not functionally related to the at least one function (step 226). The method 220 further includes funds being transferred from a third party to the first party to at least partially compensate the first party of the at least reduced cost to the second party based at least in part on display of the massage (step 228). Detail related to the method 220 is discussed above.

A method 230 is depicted in FIG. 8A as having the health care practice management system provided by a first party to a second party with at least reduced cost to the second party (step 232). Funds are transferred from a third party to the first party to at least partially compensate the first party of the least reduced cost to the second party based at least in part on display of at least one message through the health care practice management system (step 234) to at least one personnel associated with the second party while using the health care practice management system.

The health care practice management platform 110 receives data from the at least one personnel associated with the second party by way of one of the practitioner communication devices 104 as part of performance of one or more functions by the health care practice management system 100 through use by the at least one personnel (step 236). Access is provided for a fourth party to at least a portion of the data in at least summary form received from the at least one personnel associated with the second party (step 238). The at least a portion of the data is typically received by the fourth party in a summary form to maintain any confidential nature of the data. Funds are transferred from the fourth party to the first party as associated with the access to the at least a portion of the data provided to the at least one personnel of the fourth party (step 240).

FIG. 9 shows an exemplary screenshot for appointments and includes sponsored messages related to CDC announcements, influenza, and anti-inflammatory research.

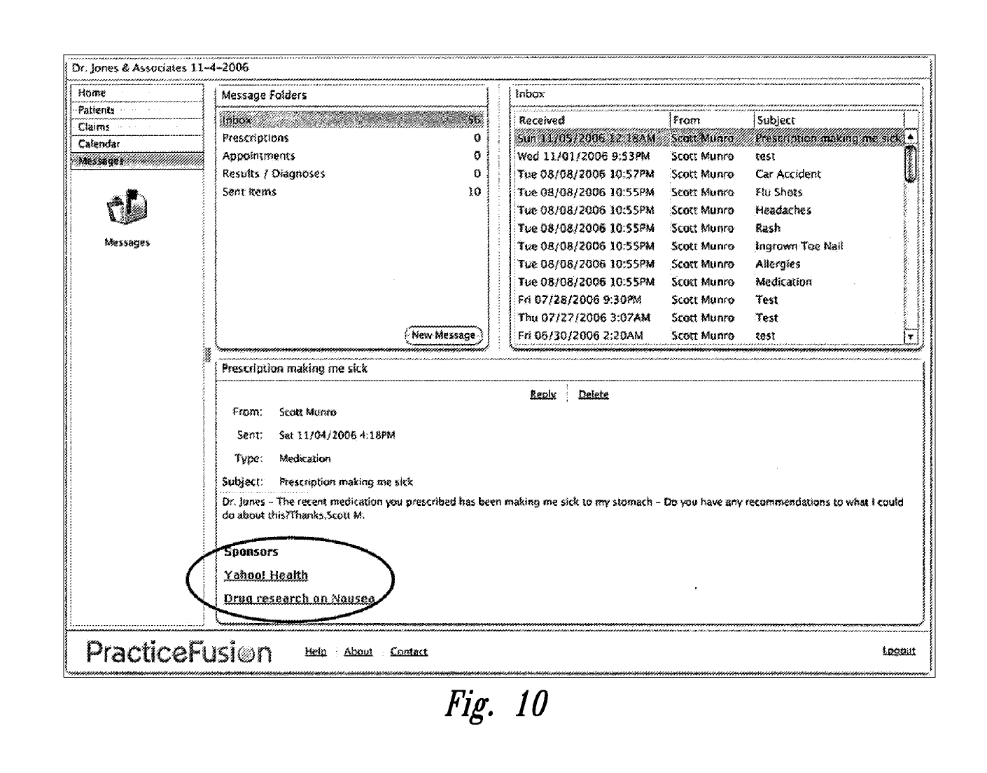

FIG. 10 shows an exemplary screenshot for messaging and links to sponsored messages regarding drug research and naseau.

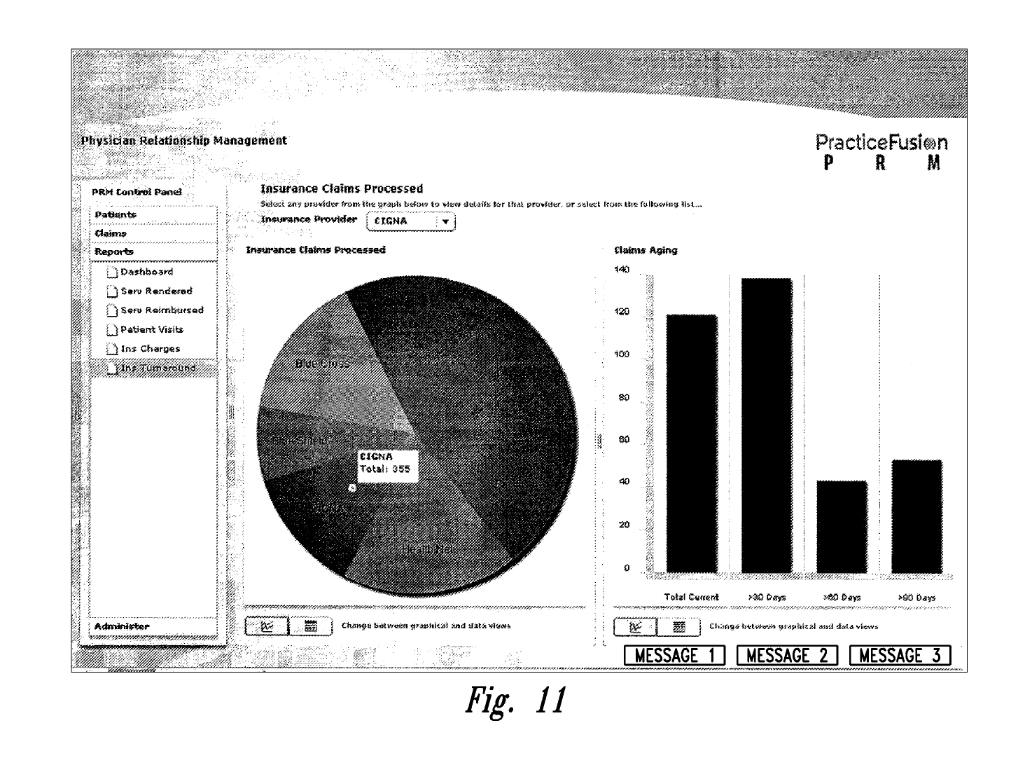

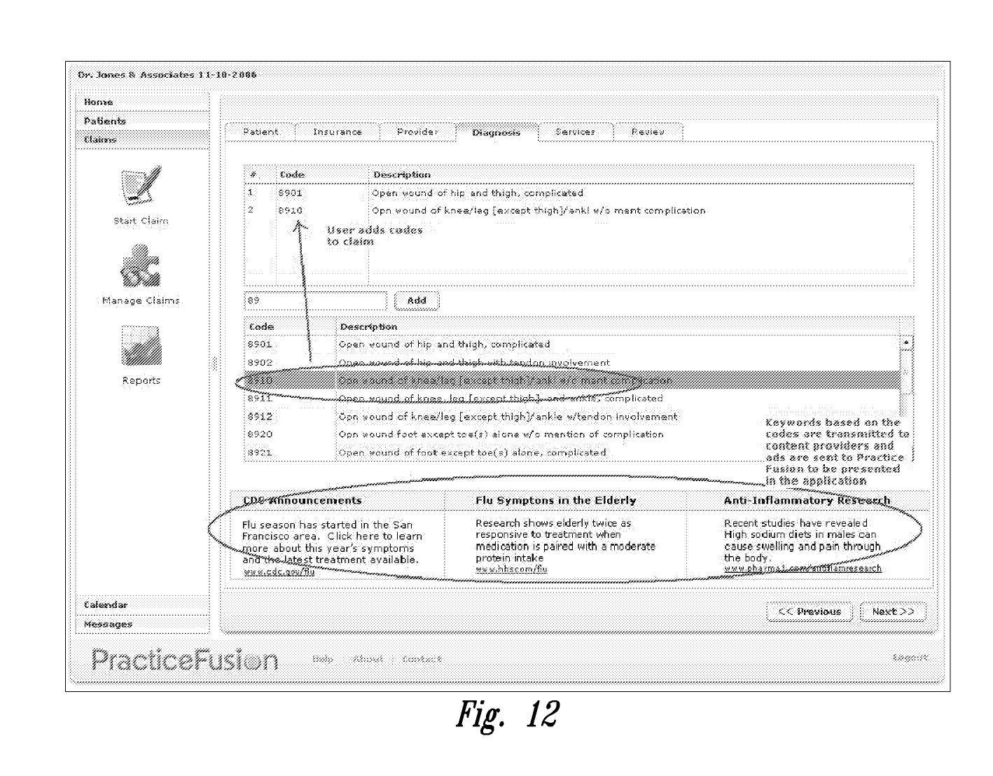

FIG. 11 shows an exemplary screenshot for insurance claims and sponsored messages generally indicated by “message 1”, “message 2”, and “message 3” which symbolically represent any sort of message that could be sponsored, such as a message that is triggered by some functional action invoked by a user or triggered by some keyword or other input by a user, or a message that is predefined to appear at a certain time sequence, action sequence or other such event.

FIG. 12 shows an exemplary screenshot for a patient diagnosis and sponsored messages regarding CDC announcements, influenza, and anti-inflammatory research.

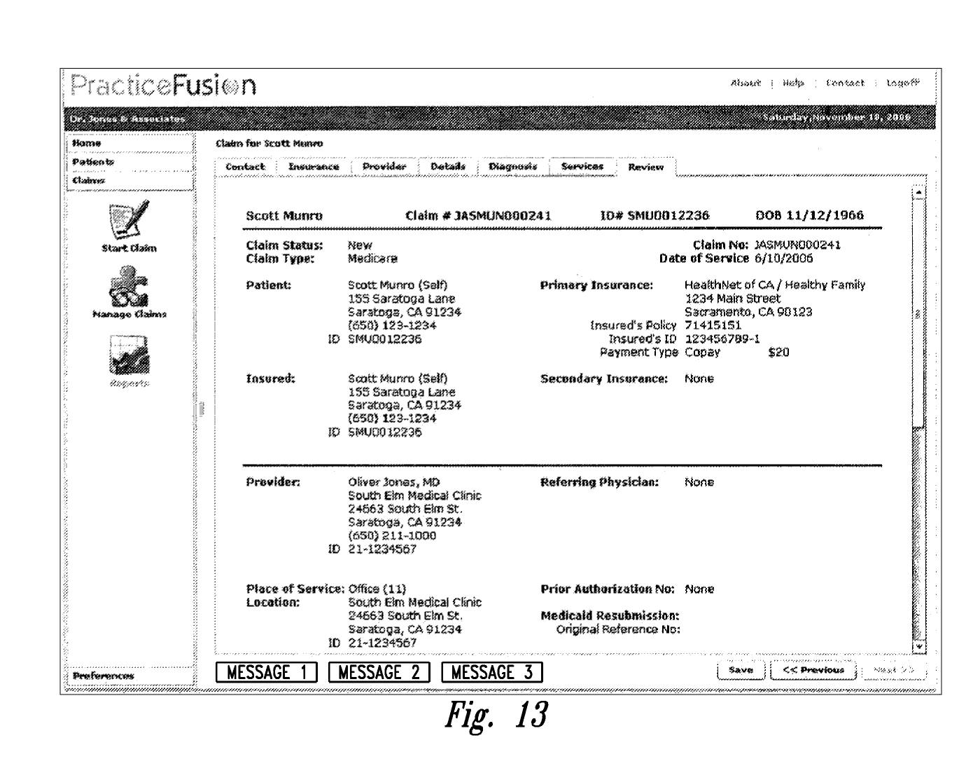

FIG. 13 shows an exemplary screenshot for patent demographics and insurance information.

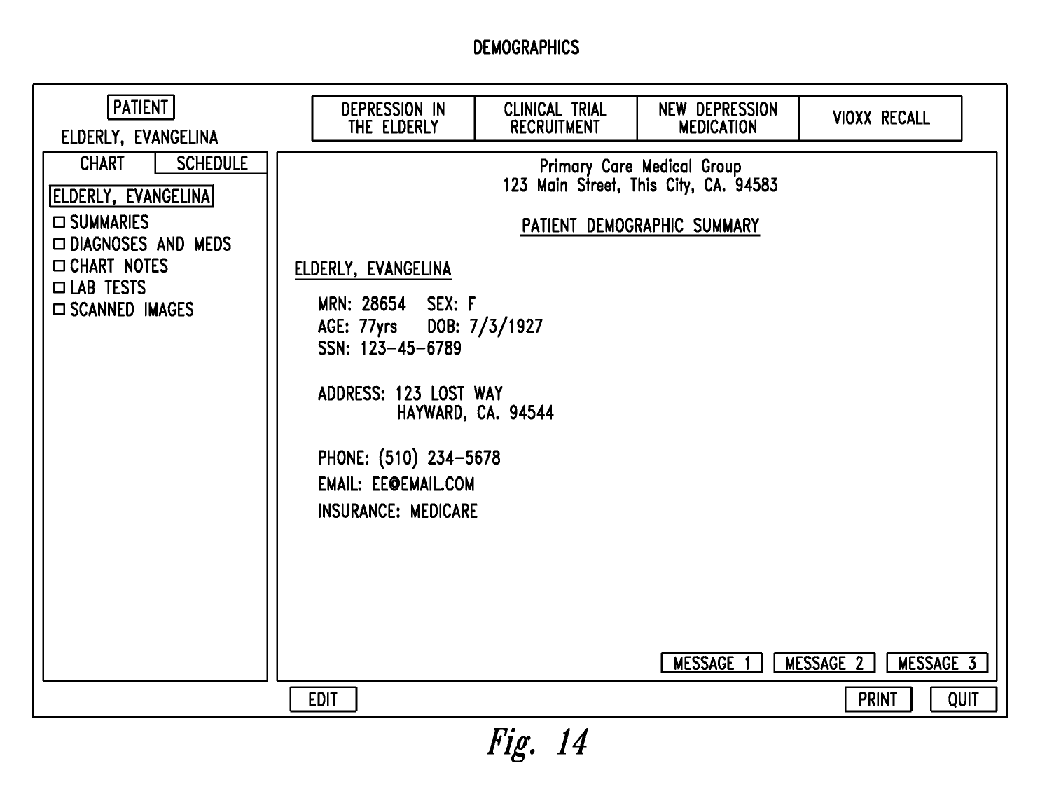

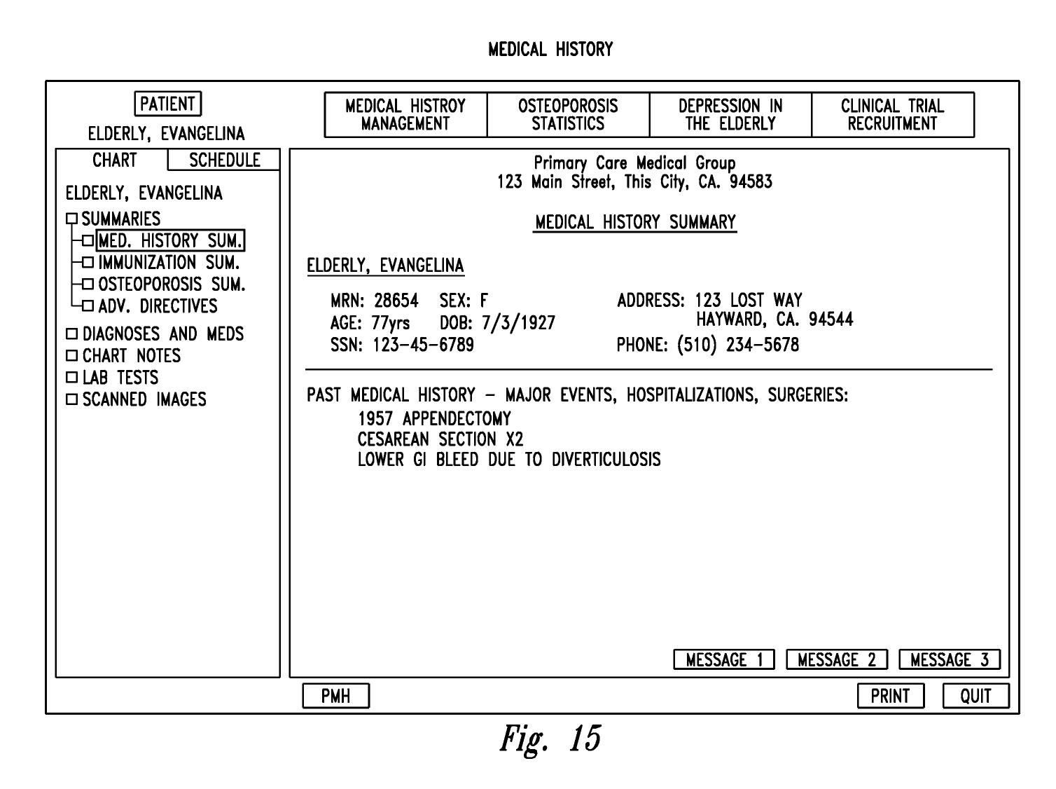

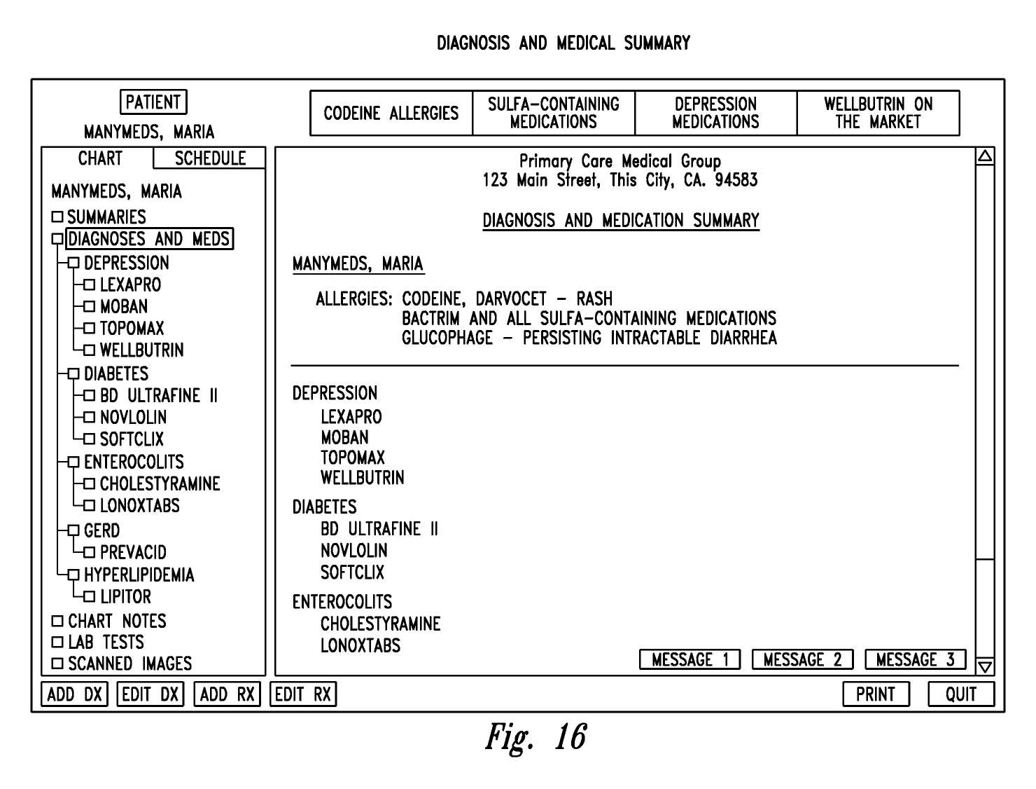

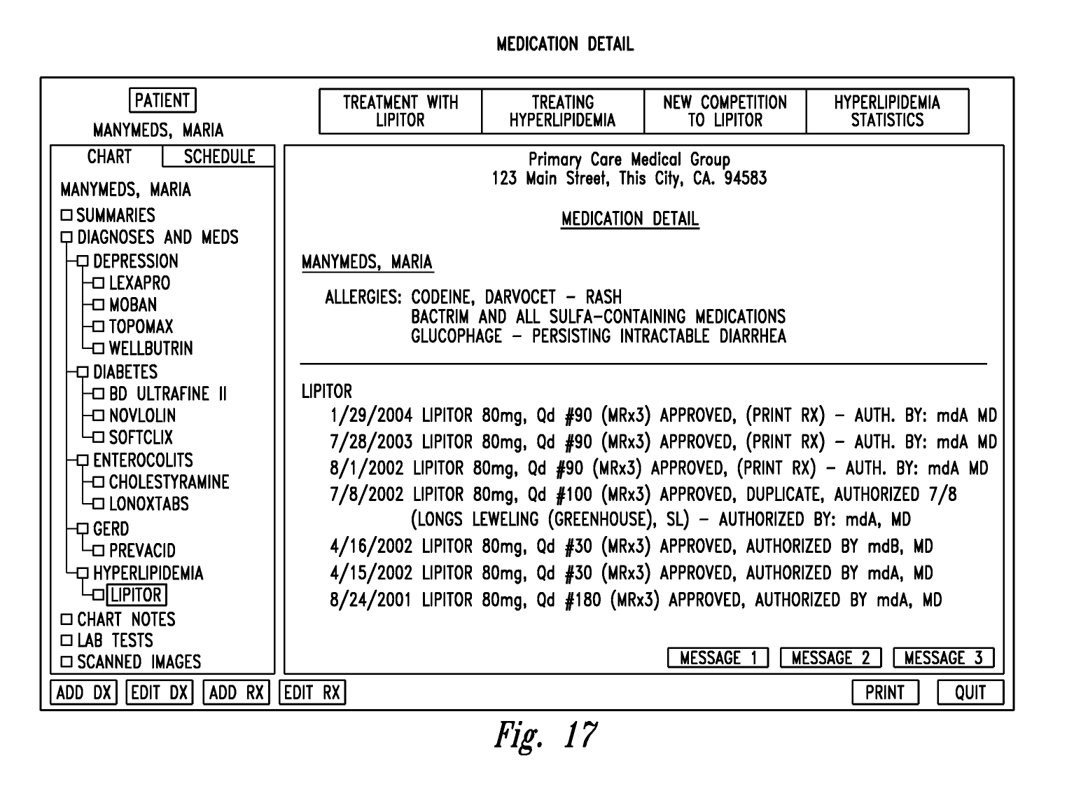

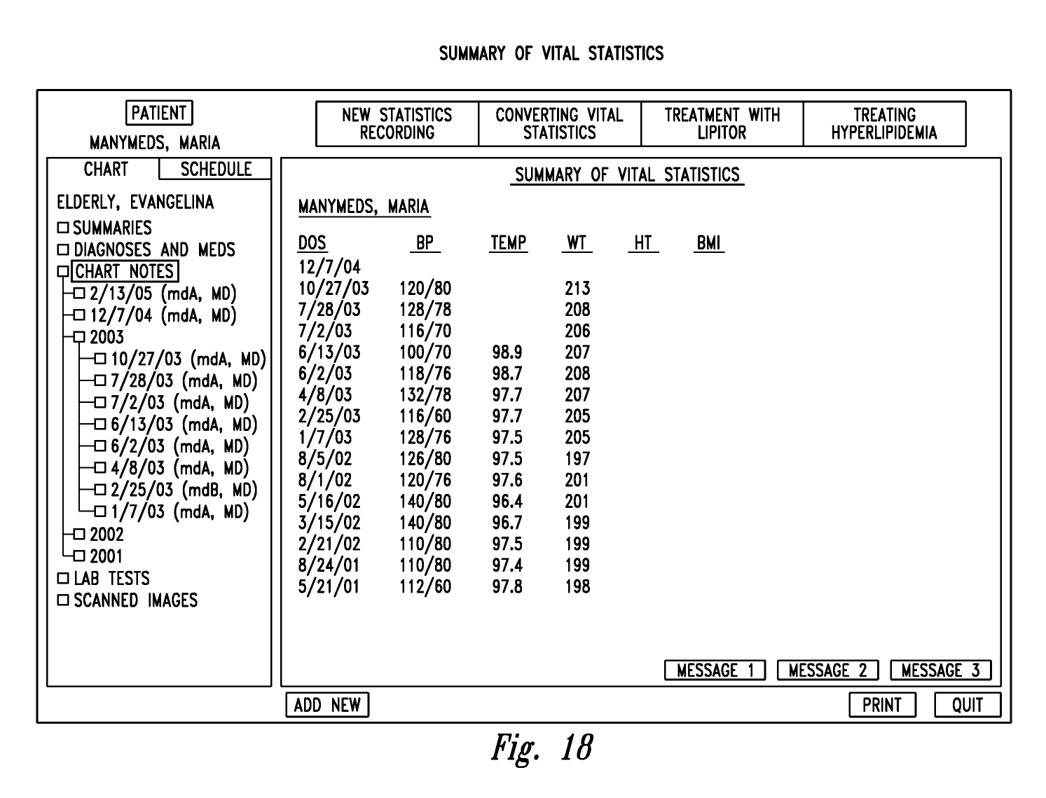

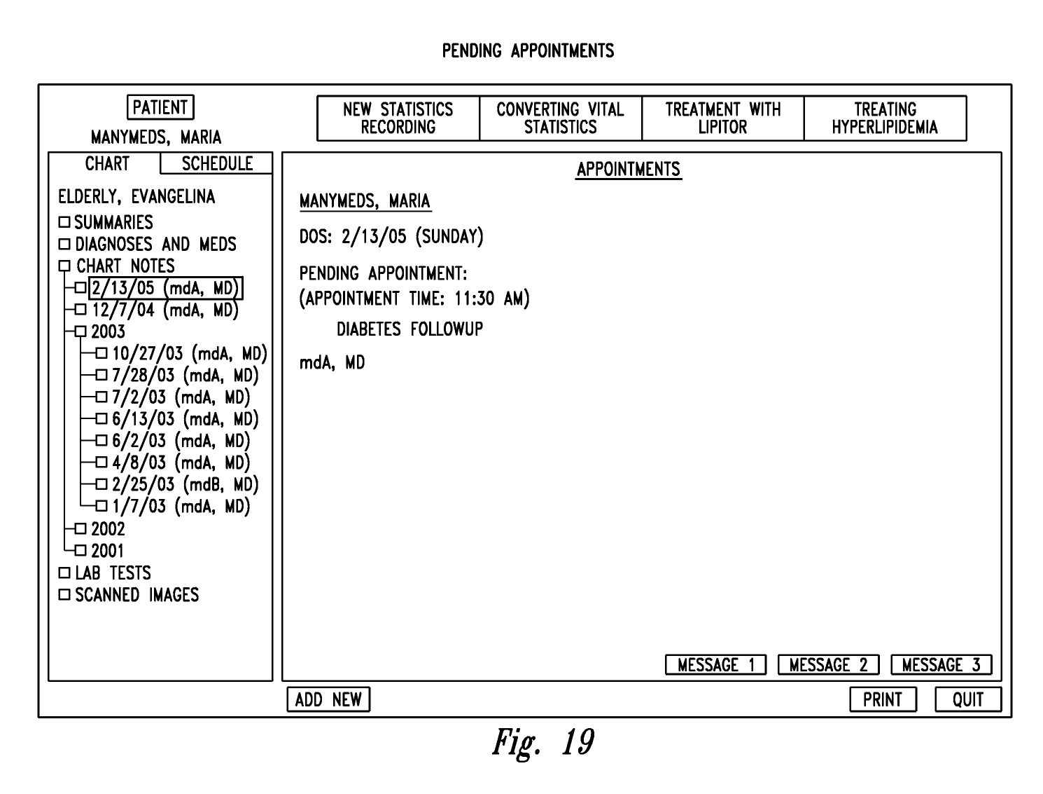

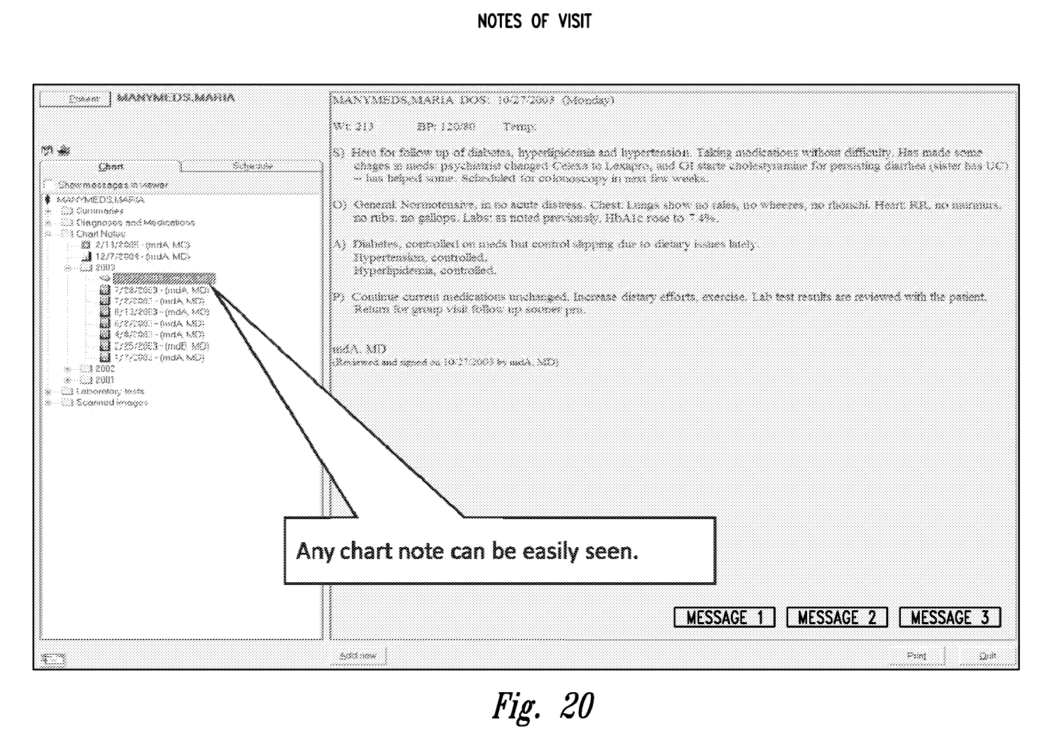

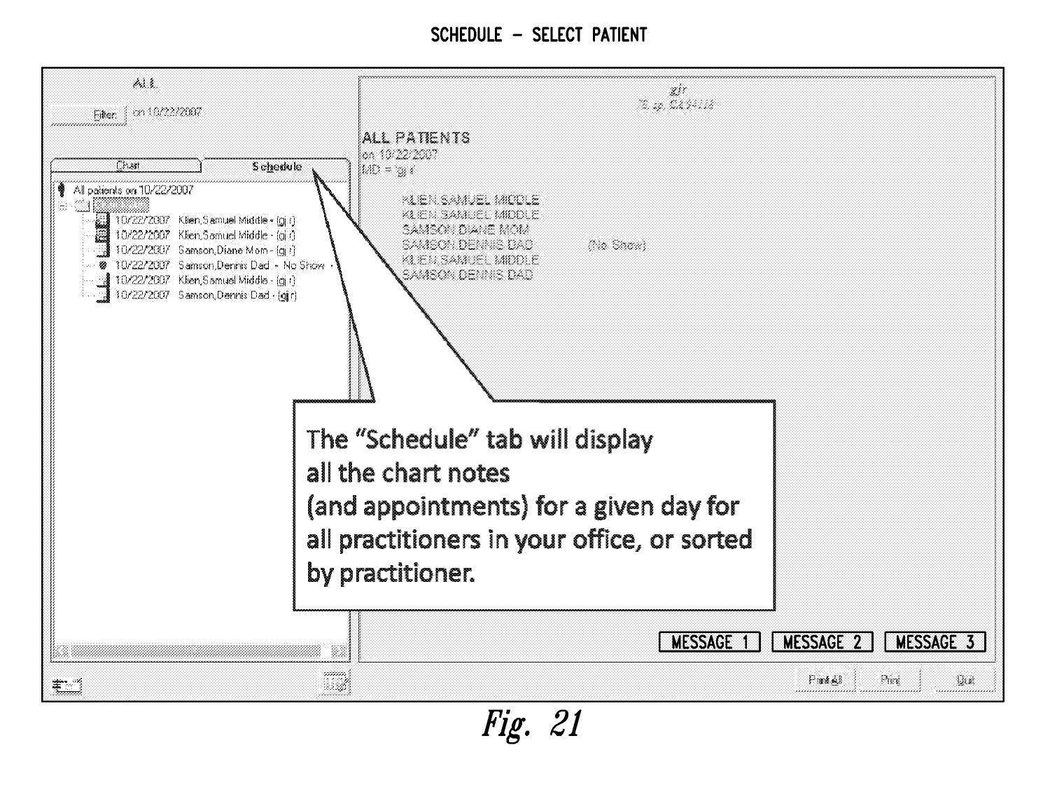

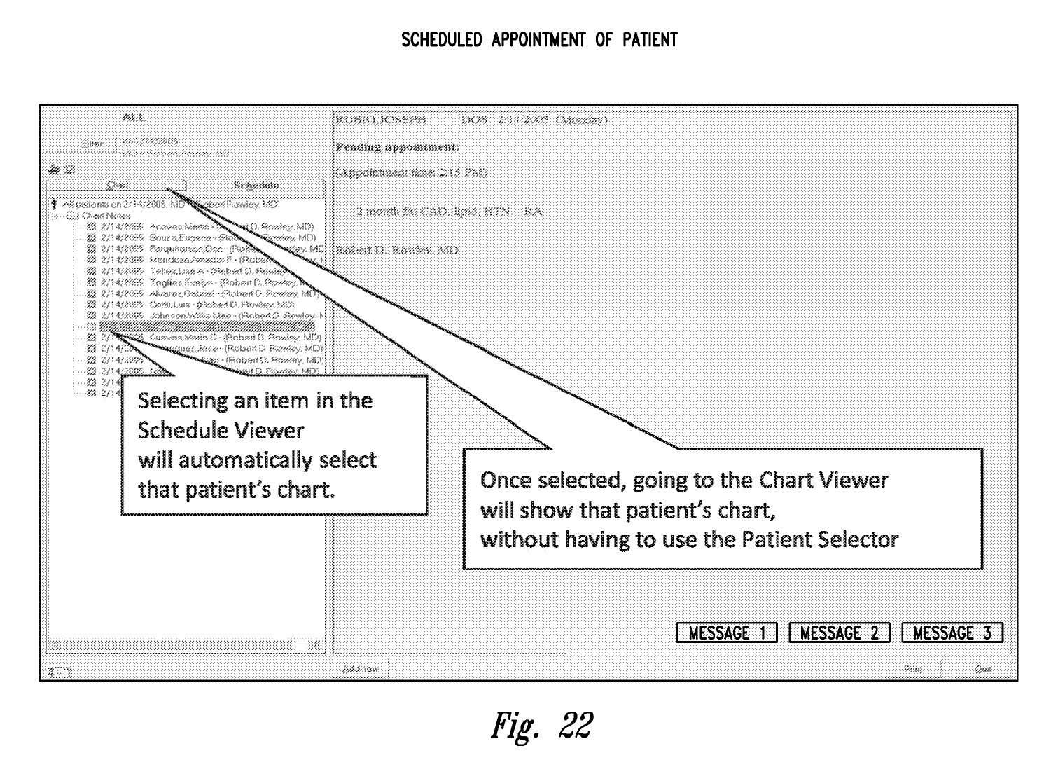

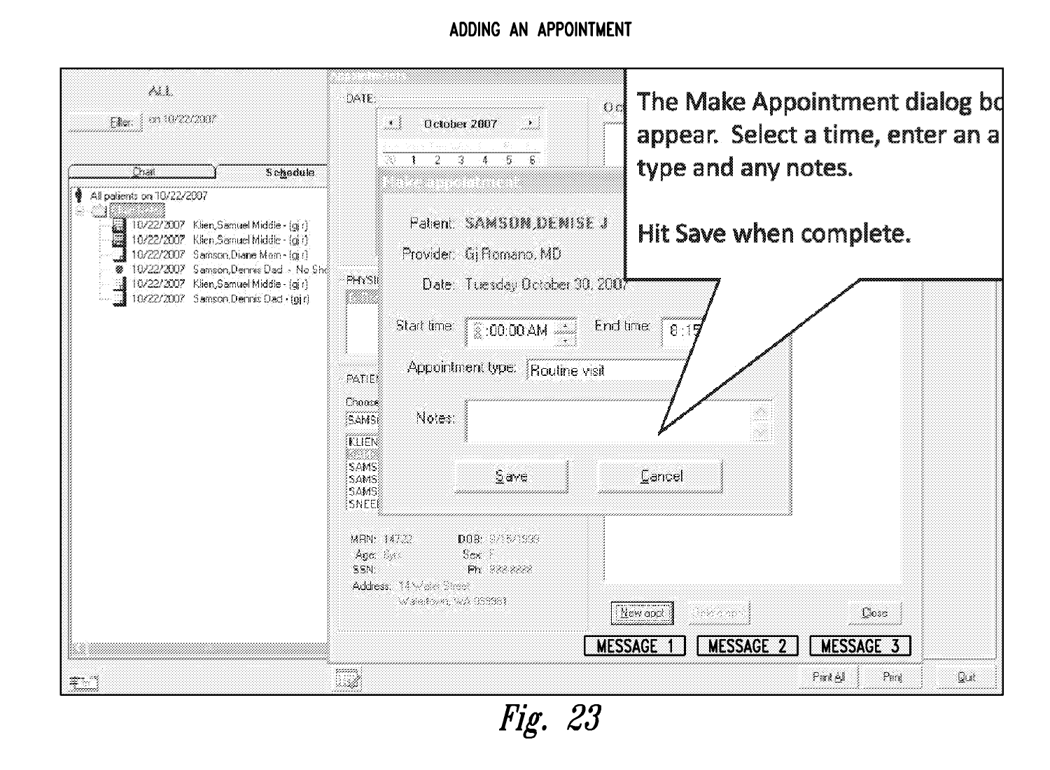

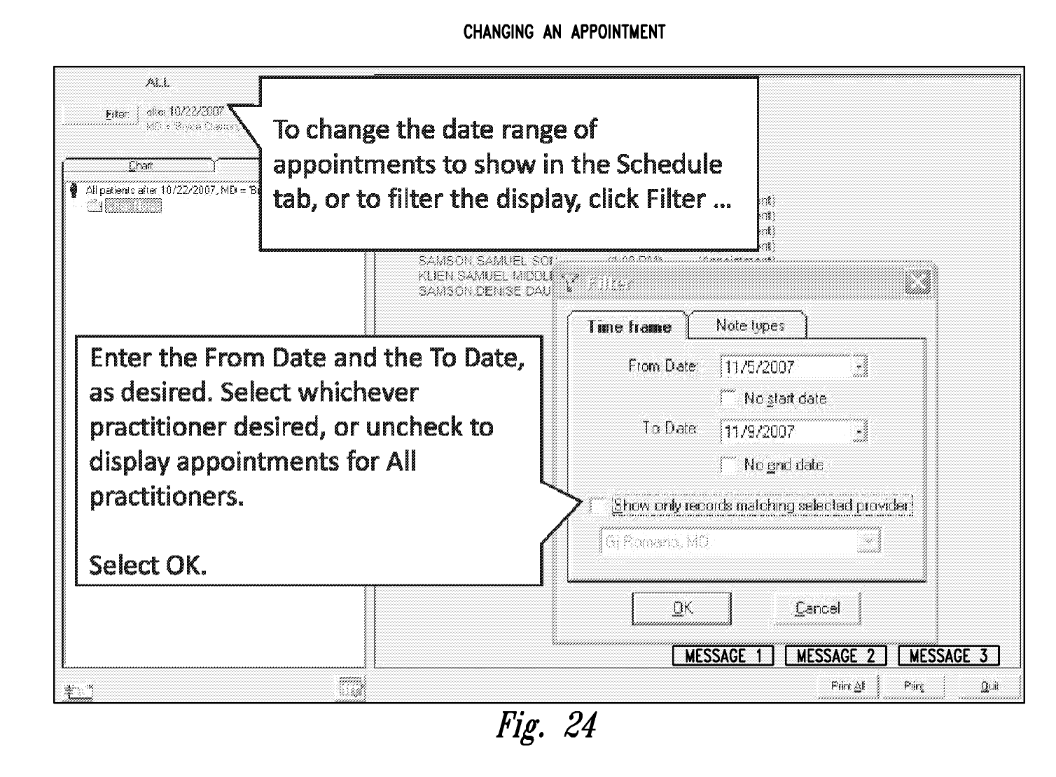

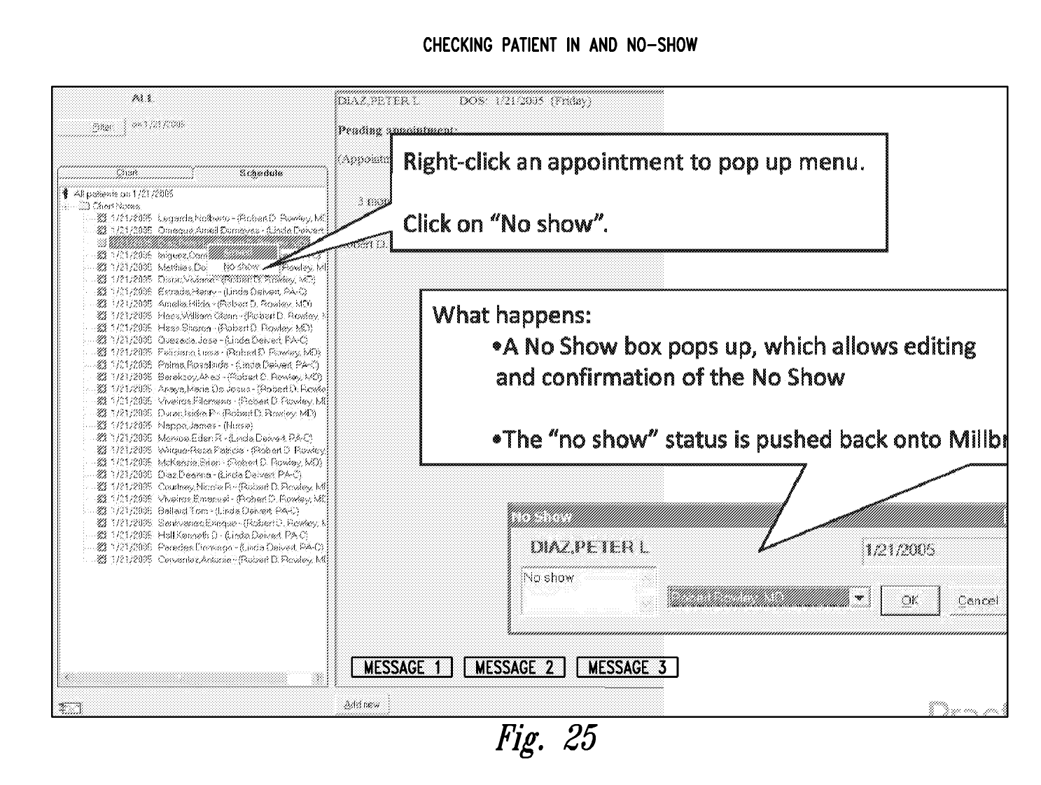

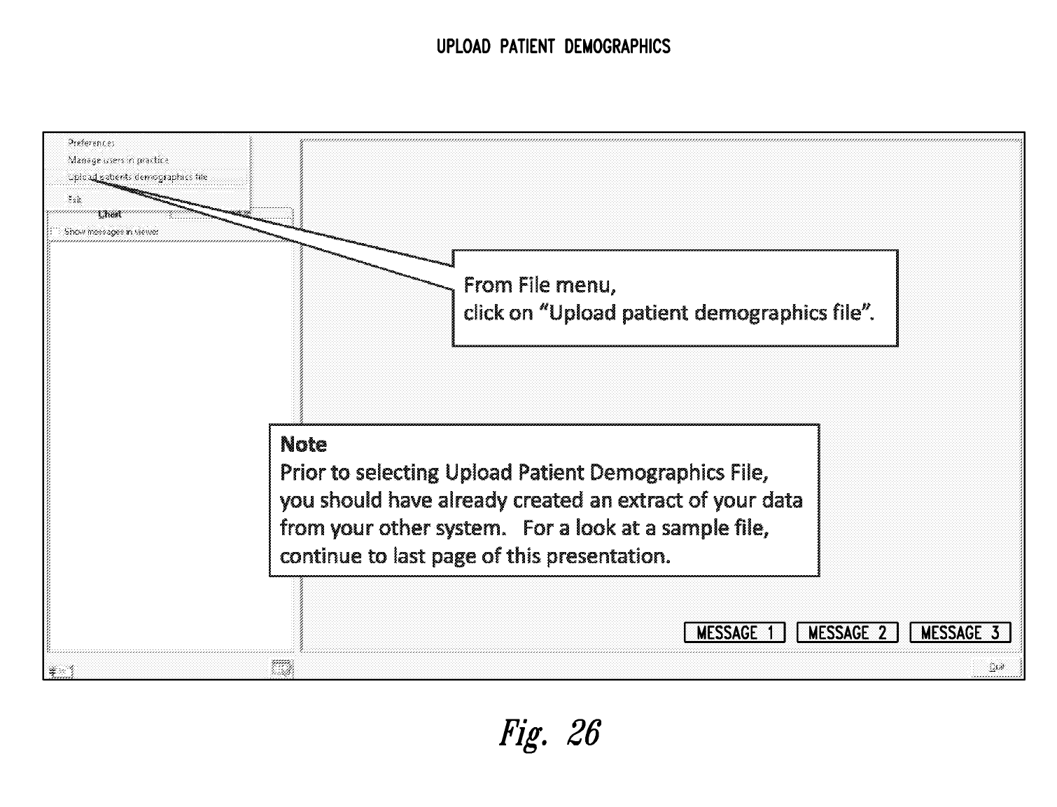

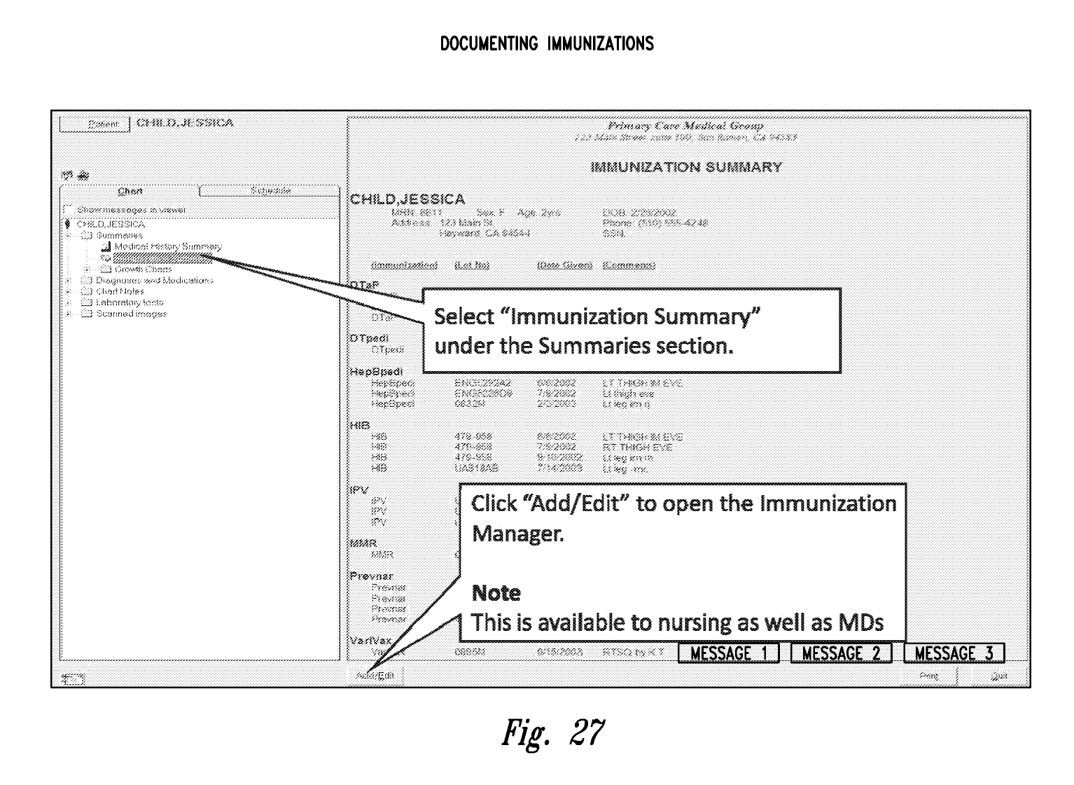

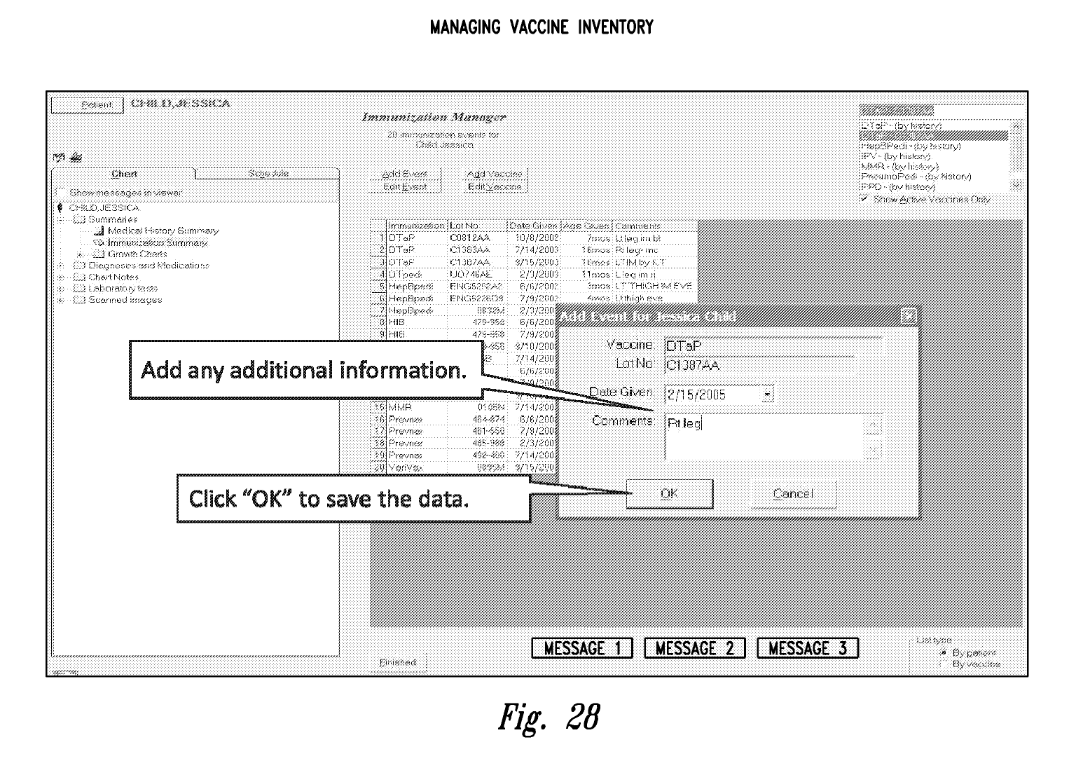

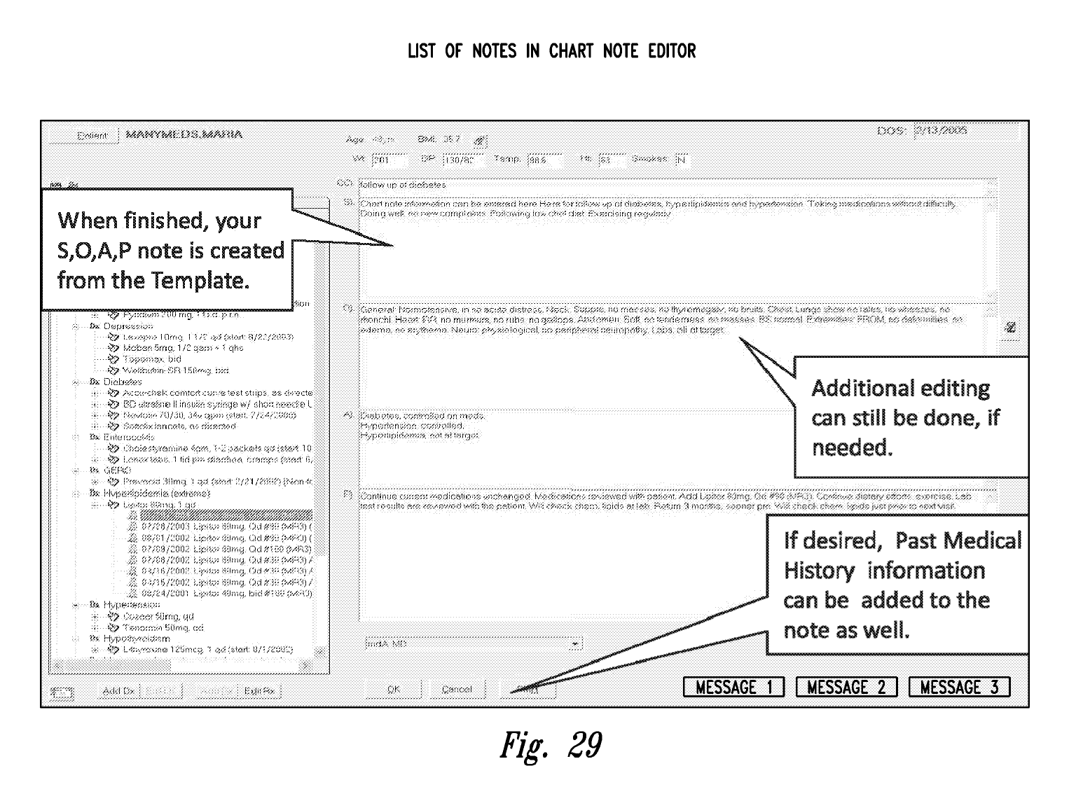

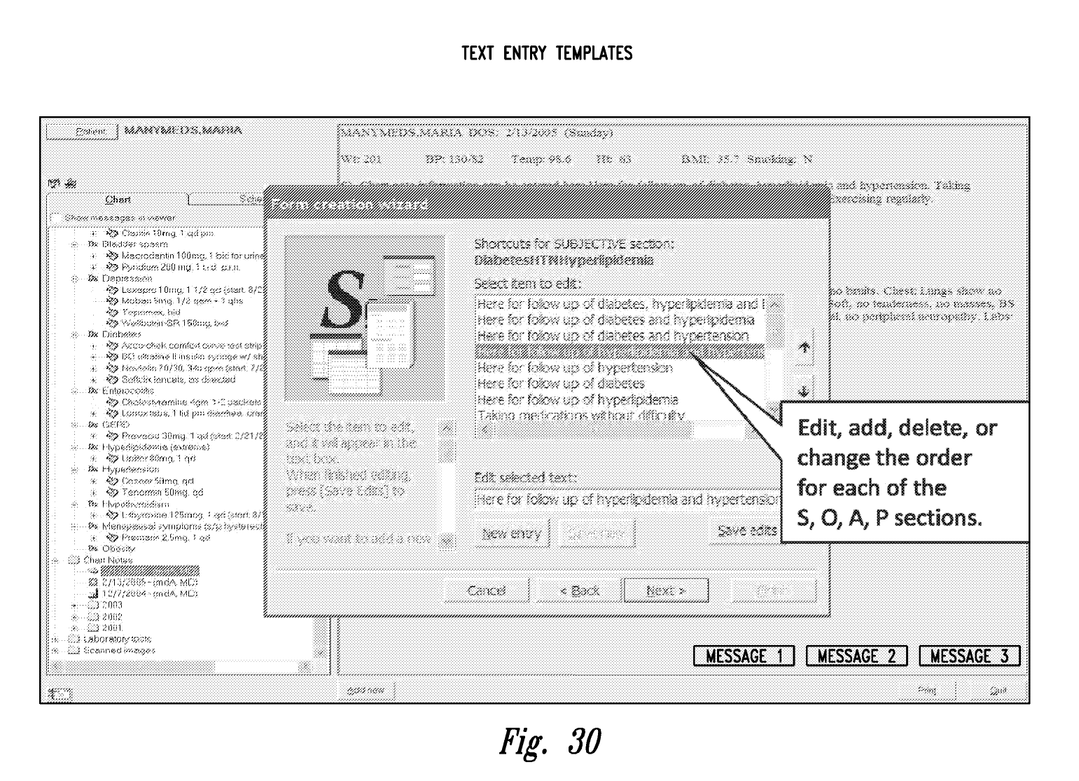

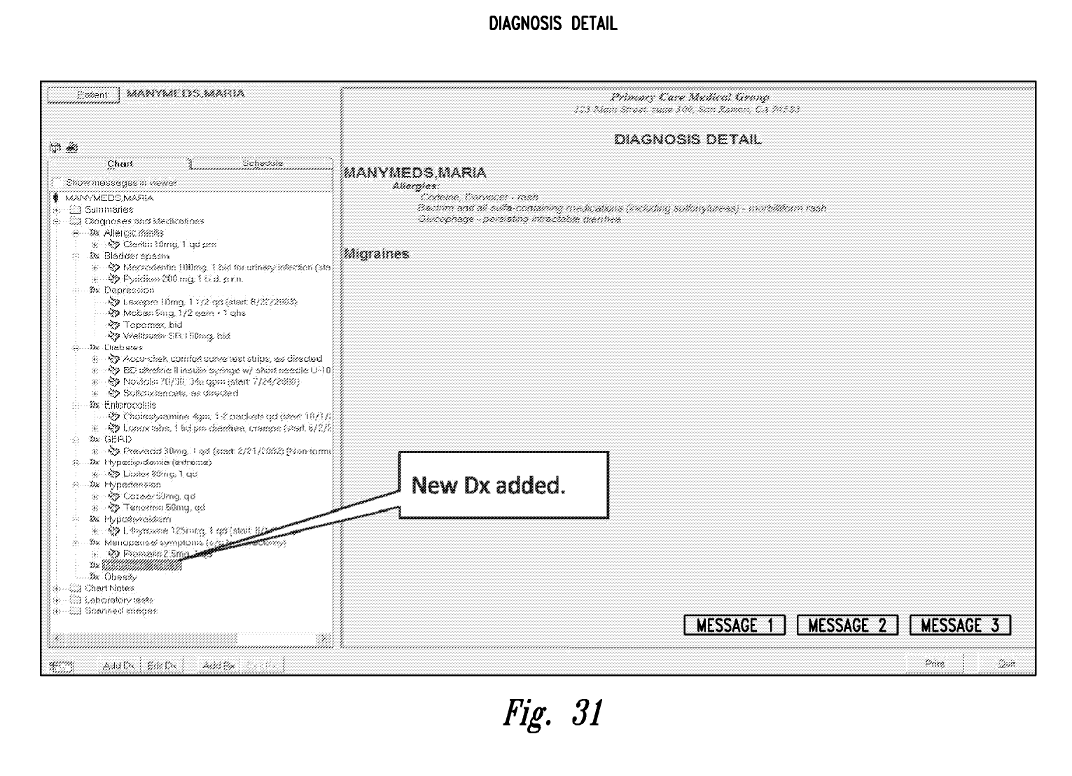

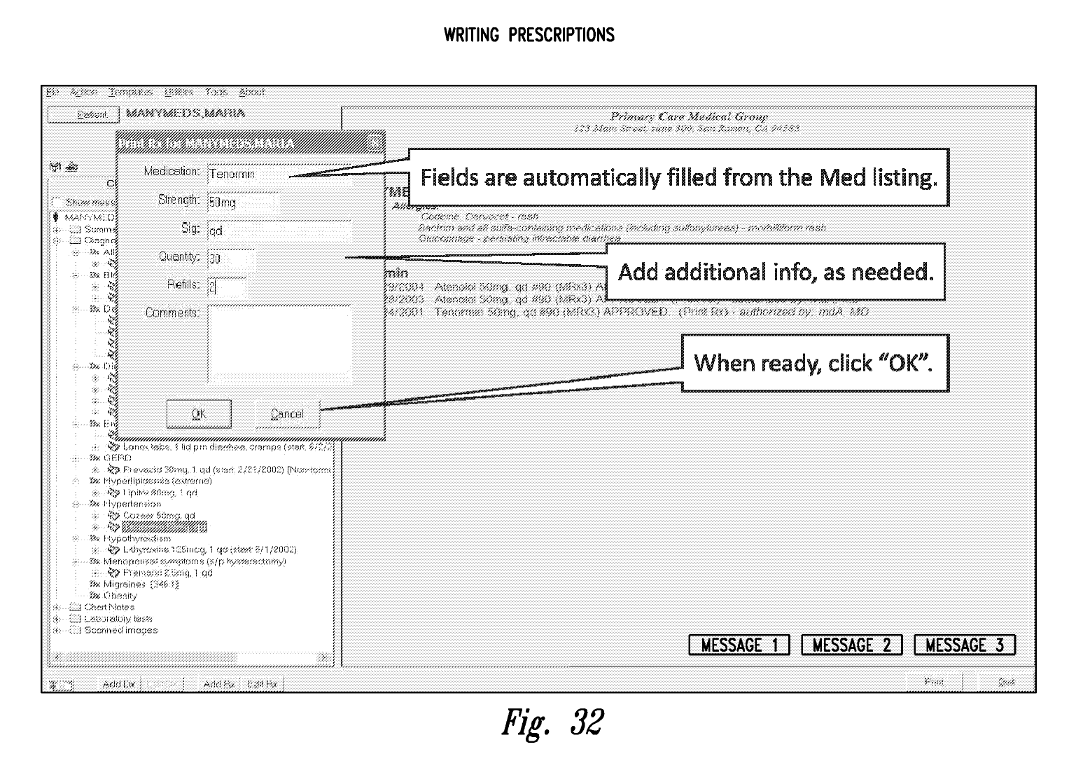

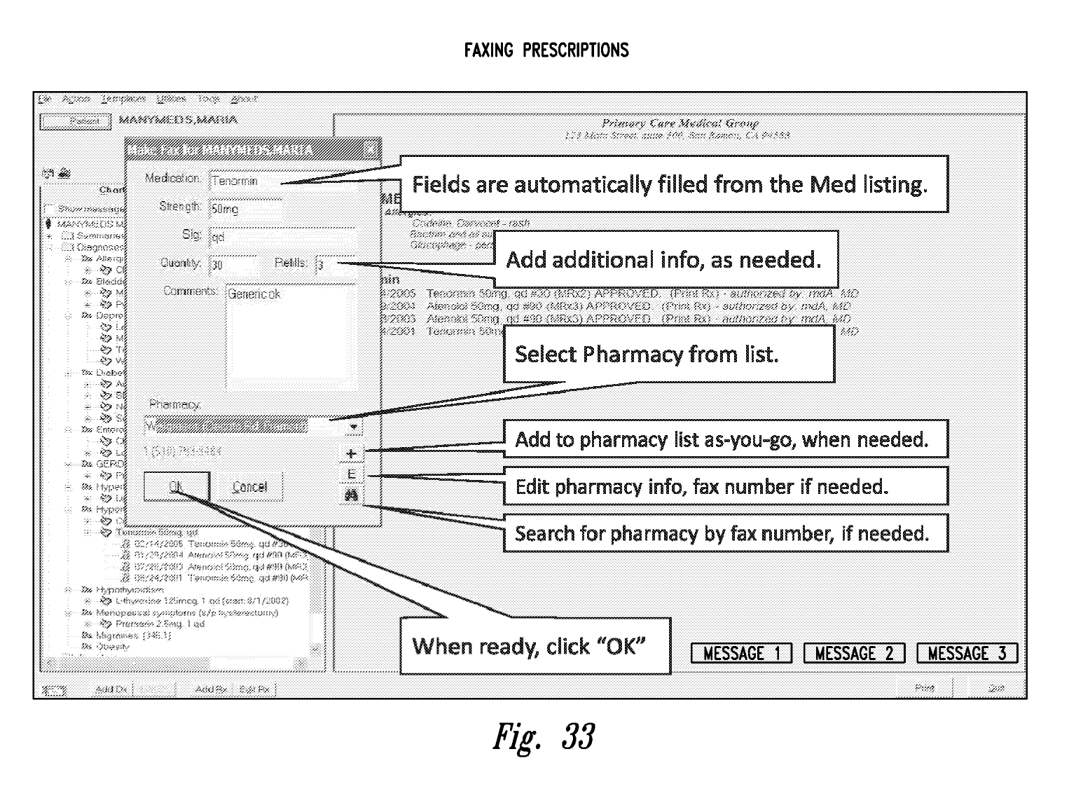

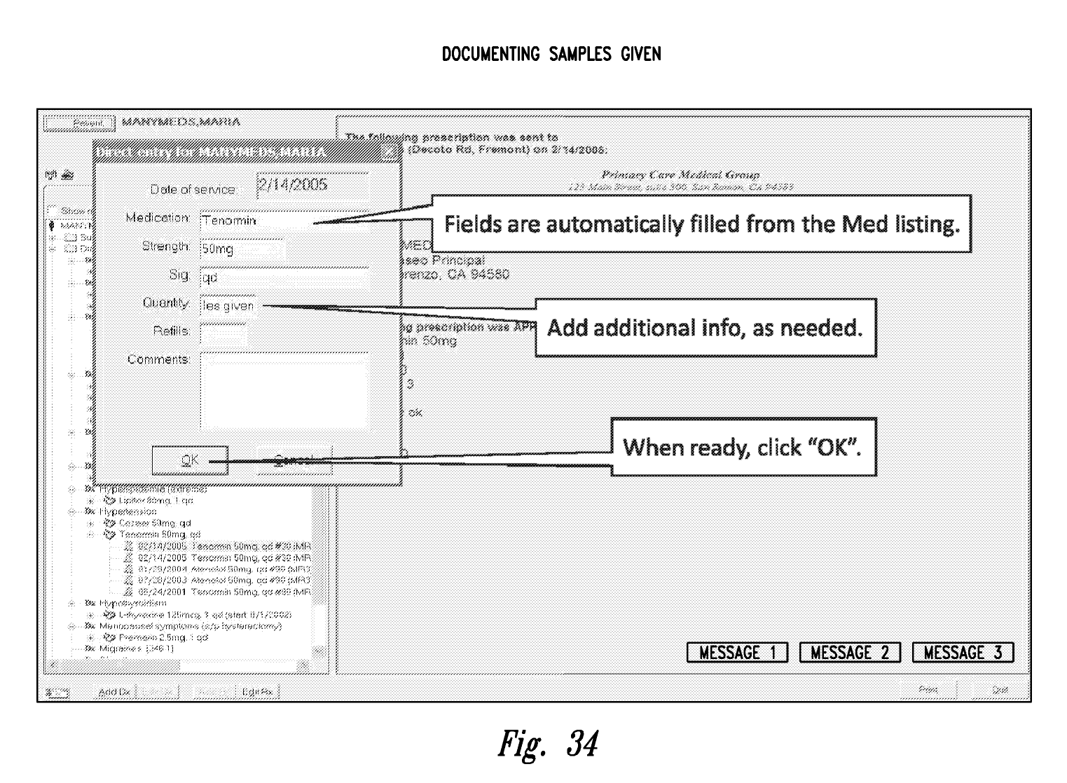

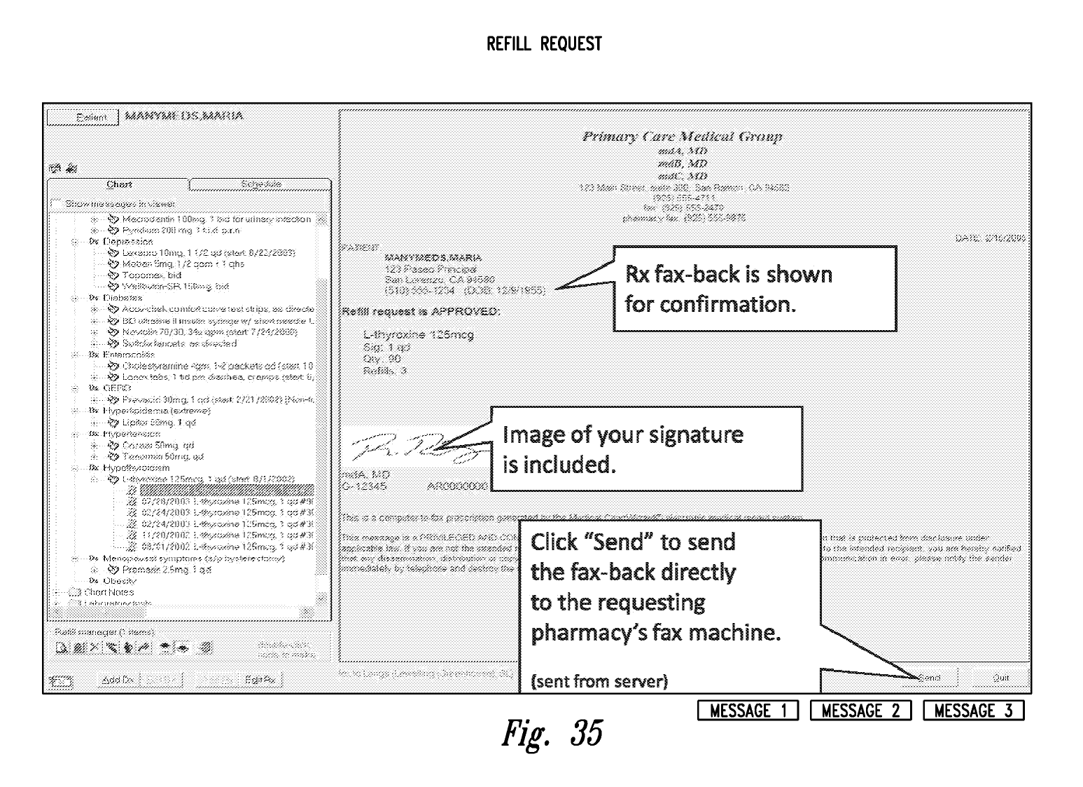

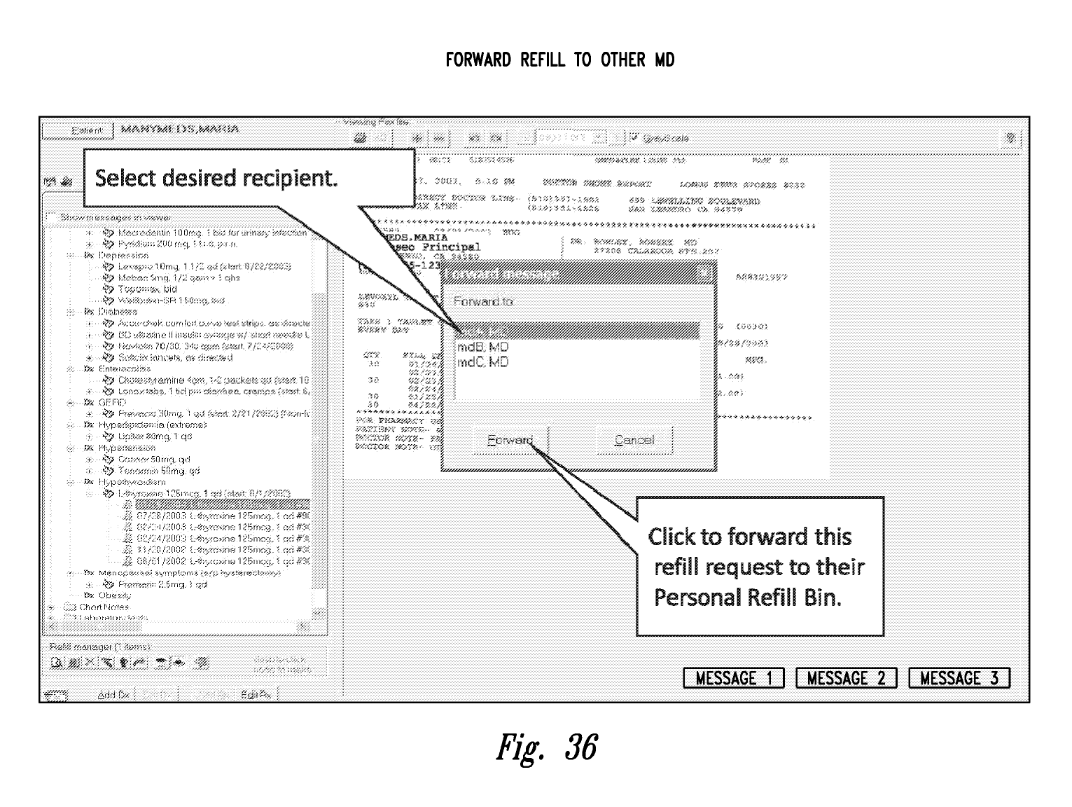

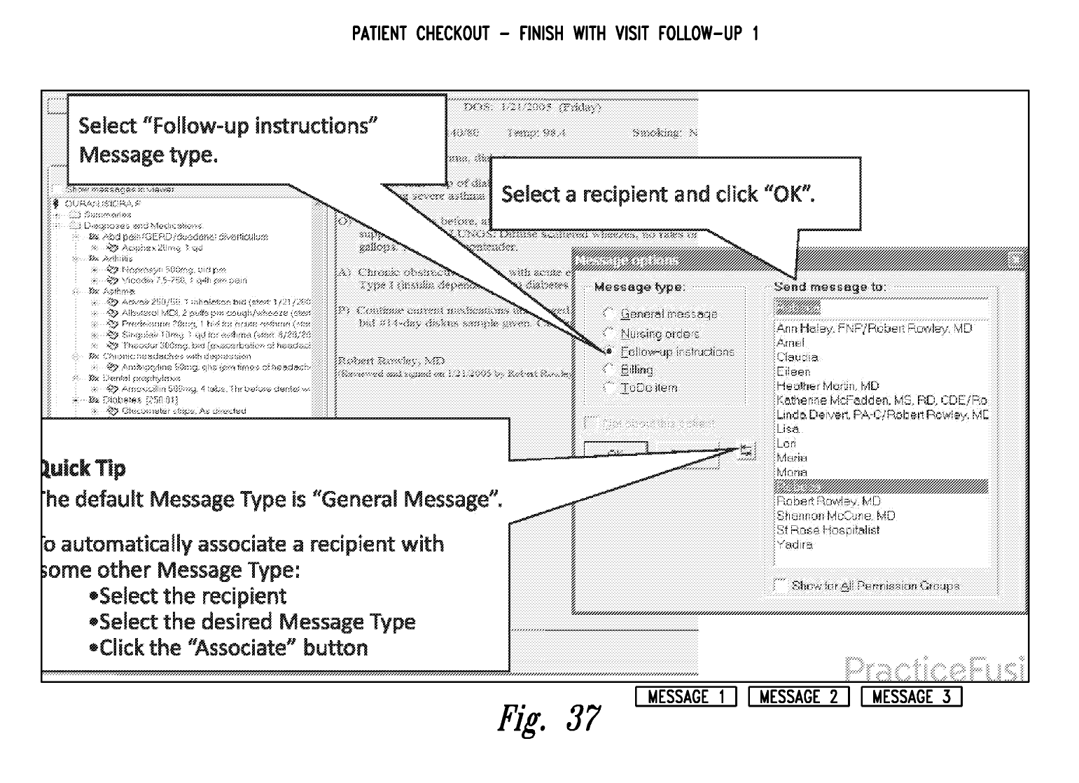

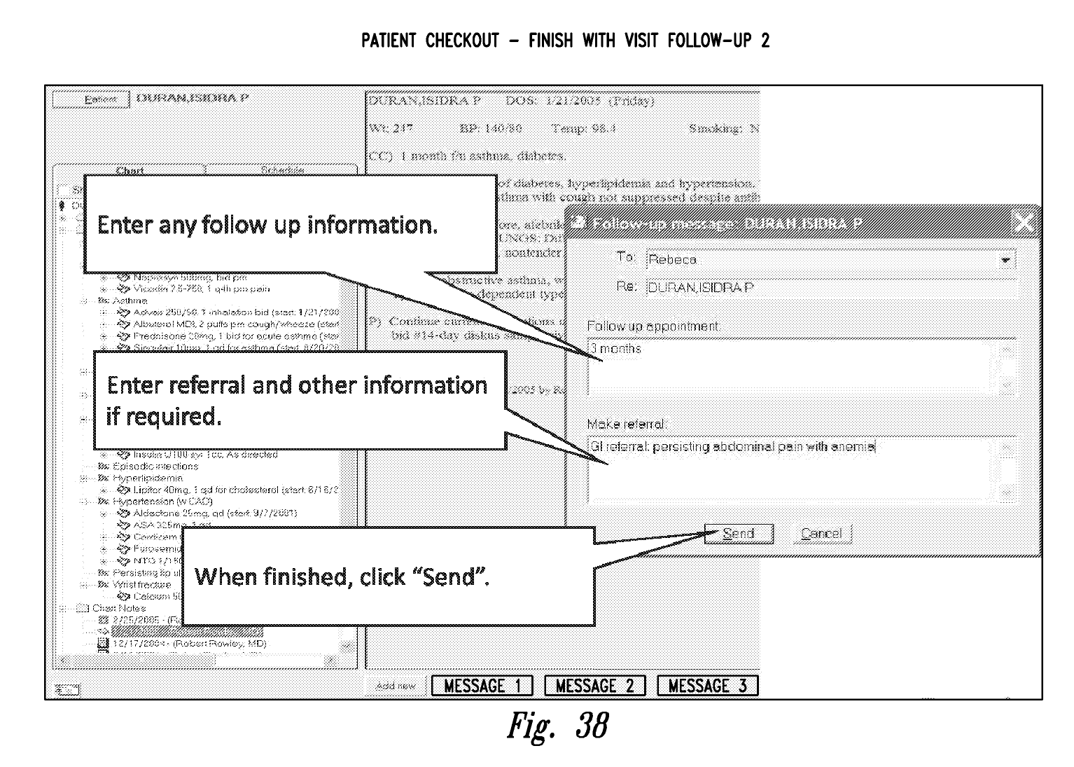

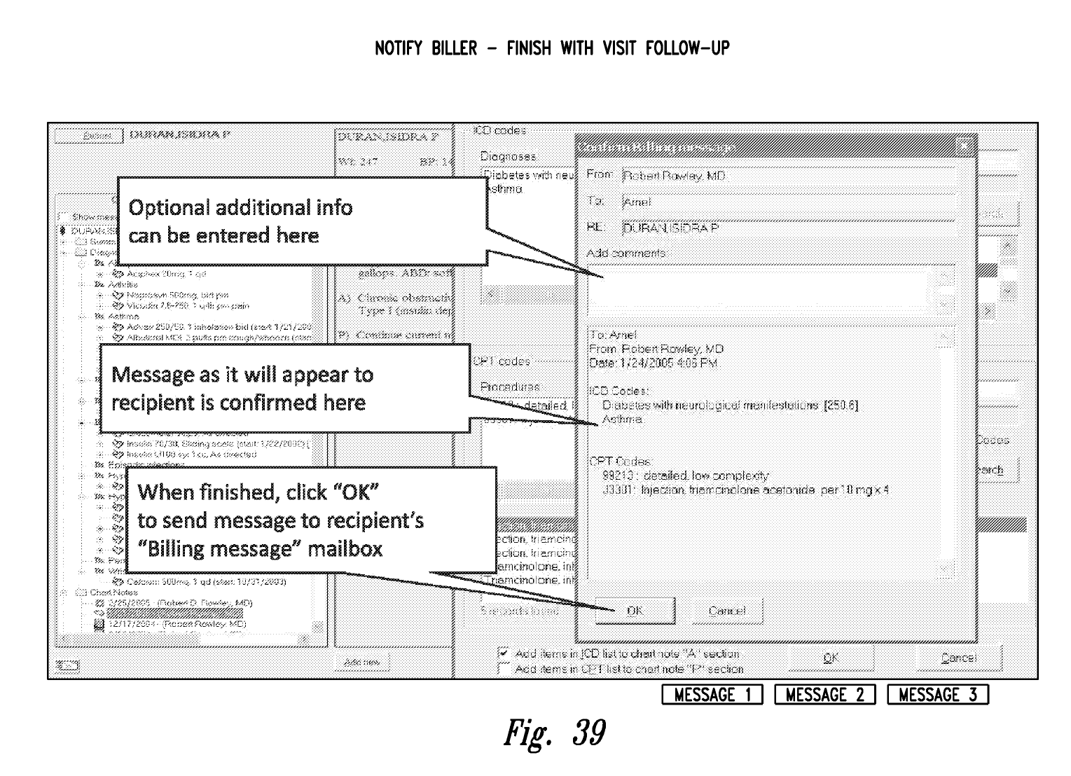

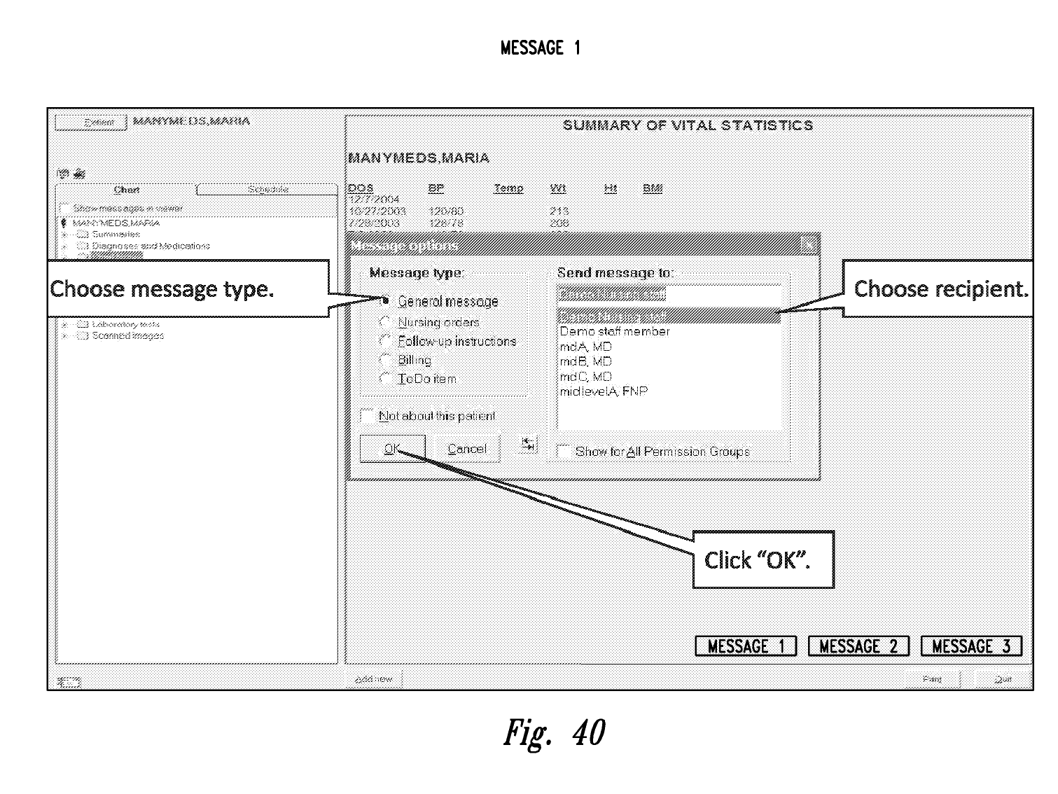

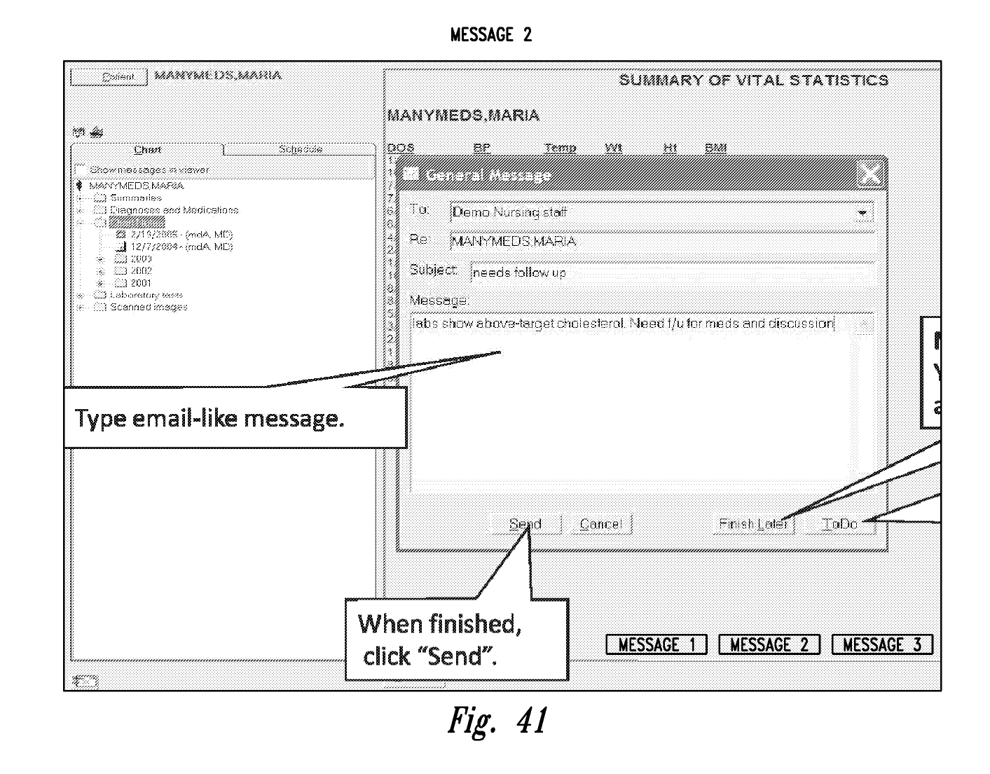

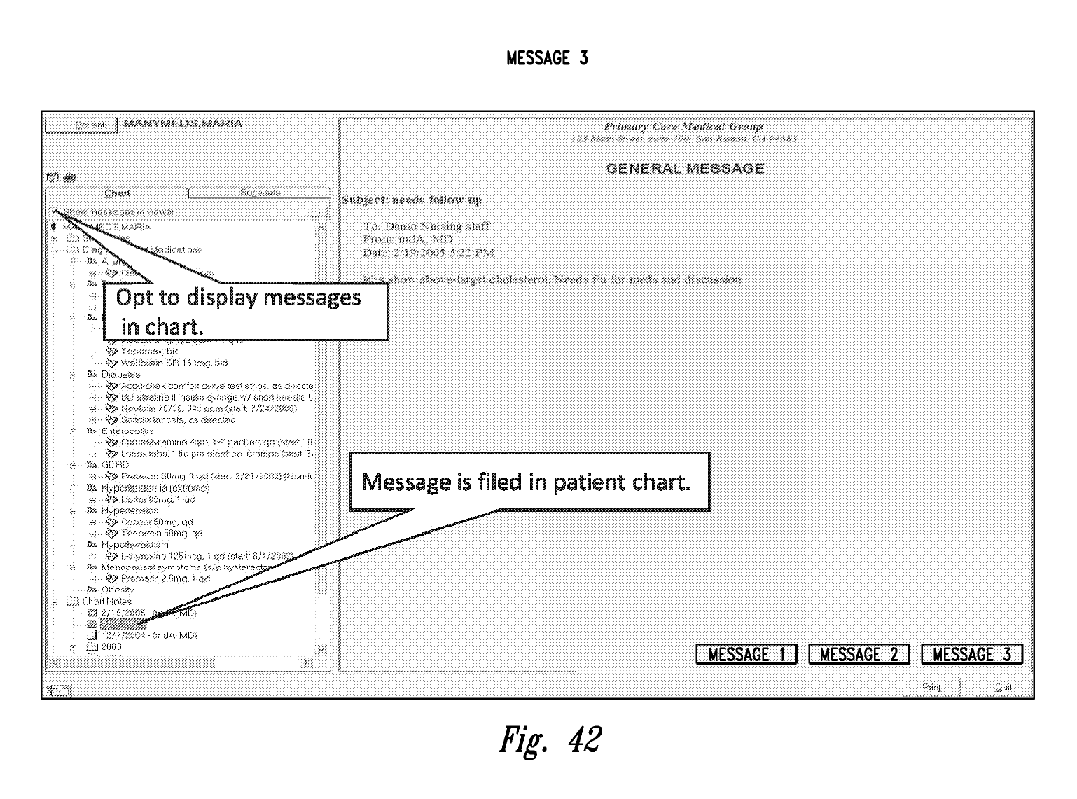

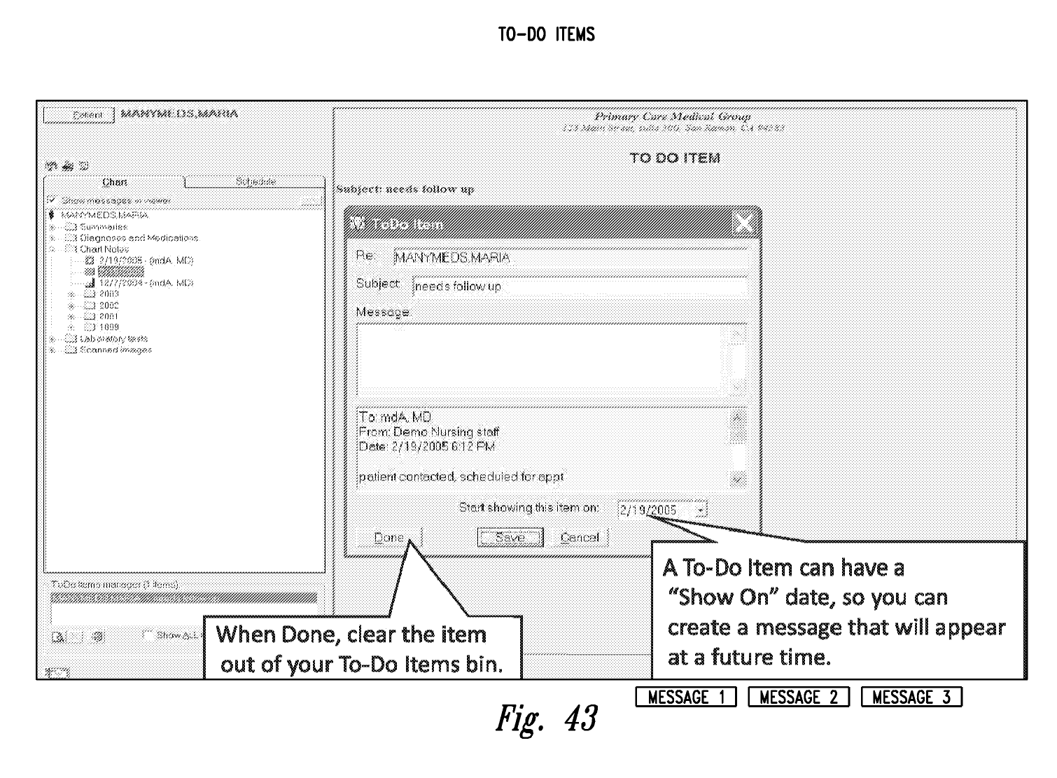

FIGS. 14-43 are exemplary screenshots presented by the health care practice management system 100 for various functional aspects provided to a user such as related to demographics and/or medical history, and/or diagnosis and medication summary, and/or medication detail, and/or summary of vital statistics, and/or pending appointments, and/or notes of visit, and/or schedule—select patient, and/or scheduled appointment of patient, and/or adding an appointment, and/or changing an appointment, and/or checking patient in and no-show and/or upload patient demographics, and/or documenting immunizations, and/or managing vaccine inventory, and/or list of notes in chart note editor, and/or text entry templates, and/or managing diagnosis, and/or diagnosis detail, and/or writing prescriptions, and/or faxing prescriptions, and/or documenting samples given, and/or refill request, and/or forward refill to other MD, and/or MDs personal refill bin, and/or patient check-out—finish with visit follow-up, and/or notify biller—finsh with visit follow-up, and/or different sorts of messages, and/or general messages, and/or to do items. Each of the exemplary screenshots of FIGS. 14-43 contain sponsored messages generally indicated by “message 1”, “message 2”, and “message 3” which symbolically represent any sort of message that could be sponsored, such as a message that is triggered by some functional action invoked by a user or triggered by some keyword or other input by a user, or a message that is predefined to appear at a certain time sequence, action sequence or other such event.

In one or more various implementations, related systems include but are not limited to circuitry and/or programming for effecting the foregoing-referenced method implementations; the circuitry and/or programming can be virtually any combination of hardware, software, and/or firmware configured to effect the foregoing-referenced method implementations depending upon the design choices of the system designer.

The foregoing provides exemplary descriptions and thus contains, by necessity; simplifications, generalizations and omissions of detail; consequently, those skilled in the art will appreciate that the summary is illustrative only and is not intended to be in any way limiting. Those having ordinary skill in the art will recognize that the environment depicted has been kept simple for sake of conceptual clarity, and hence is not intended to be limiting.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed.

For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The foregoing detailed description has set forth various embodiments of the devices and/or processes via the use of block diagrams, flowcharts, and examples. Insofar as such block diagrams, flowcharts, and examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof.

Those skilled in the art will recognize that the embodiments disclosed herein, in whole or in part, can be equivalently implemented in standard or custom Integrated circuits, as one or more computer programs running on one or more computers (e.g., as one or more programs running on one or more data processing systems), as one or more programs running on one or more controllers (e.g., microcontrollers) as one or more programs running on one or more processors e.g., microprocessors, as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of the present invention are capable of being distributed as a program product in a variety of forms, and that an illustrative implementation of the present invention applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analogue communication links using TDM or IP based communication links (e.g., packet links).

In a general sense, those skilled in the art will recognize that the various implementations described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into data processing systems. That is, the devices and/or processes described herein can be integrated into a data processing system via a reasonable amount of experimentation.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is:

1. A method comprising:
receiving input from a communication device related to at least one function of a health care practice management system;
triggering display of a sponsored message not functionally related to the at least one function, the display of the sponsored message performed through the health care practice management system; and
receiving funds from a sponsor of the sponsored message based upon at least in part on display of the sponsored message.

2. The method of claim 1 wherein the at least one function is related to patient scheduling.

3. The method of claim 1 wherein the at least one function is related to prescription management.

4. The method of claim 1 wherein the at least one function is related to electronic medical recording and charting.

5. The method of claim 1 wherein the at least one function is related to patent diagnosis management.

6. The method of claim 1 wherein the at least one function is related to patient billing.

7. The method of claim 1 wherein the at least one function is related to laboratory ordering and results.

8. The method of claim 1 wherein the at least one function is related to immunization management.

9. The method of claim 1 wherein the at least one function is related to physician-to-physician messaging.

10. A method comprising:
providing a health care practice management system to a second party with at least reduced cost to the second party;
receiving input through the health care practice management system from health care personnel associated with the second party, the input related to at least one function of the health care practice management system;
upon receipt of the input, displaying a message not functionally related to the at least one function of the health care practice management system; and
receiving funds from a third party to at least partially compensate the alt least reduced cost to the second party based at least in part on display of the message.

11. The method of claim 10 wherein the at least one function is related to patient scheduling.

12. The method of claim 10 wherein the at least one function is related to prescription management.

13. The method of claim 1 wherein the at least one function is related to electronic medical recording and charting.

14. The method of claim 10 wherein the at least one function is related to patent diagnosis management.

15. The method of claim 10 wherein the at least one function is related to patient billing.

16. The method of claim 10 wherein the at least one function is related to laboratory ordering and results.

17. The method of claim 10 wherein the at least one function is related to immunization management.

18. The method of claim 10 wherein the at least one function is related to physician-to-physician messaging.

19. A method comprising:
providing a health care practice management system to a second party with at least reduced cost to the second party;
receiving funds from a third party to at least partially compensate for the at least reduced cost to the second party of the health care practice management system based at least in part on display of a message within the health care practice management system;
receiving data through the health care practice management system from health care personnel associated with the second party;
providing access for at least one personnel of a fourth party to at least a portion of the data; and
receiving funds from the fourth party based at least in part upon the at least one personnel of the fourth party to at least a portion of the data.

20. The method of claim 19 wherein display of the message is done upon performance of at least one function related to patient scheduling.

21. The method of claim 19 wherein display of the message is done upon performance of at least one function related to prescription management.

22. The method of claim 19 wherein display of the message is done upon performance of at least one function related to electronic medical recording and charting.

23. The method of claim 19 wherein display of the message is done upon performance of at least one function related to patent diagnosis management.

24. The method of claim 19 wherein display of the message is done upon performance of at least one function related to patient billing.

25. The method of claim 19 wherein display of the message is done upon performance of at least one function related to laboratory ordering and results.

26. The method of claim 19 wherein display of the message is done upon performance of at least one function related to immunization management.

27. The method of claim 19 wherein display of the message is done upon performance of at least one function related to physician-to-physician messaging.

28. A computer readable media containing instructions to perform a method comprising:
receiving input from a communication device related to at least one function of a health care practice management system; and
triggering display of a sponsored message not functionally related to the at least one function, the display of the sponsored message performed through the health care practice management system.

29. The computer readable media of claim 28 wherein the at least one function is related to patient scheduling.

30. The computer readable media of claim 28 wherein the at least one function is related to prescription management.

31. The computer readable media of claim 28 wherein the at least one function is related to electronic medical recording and charting.

32. The computer readable media of claim 28 wherein the at least one function is related to patent diagnosis management.

33. The computer readable media of claim 28 wherein the at least one function is related to patient billing.

34. The computer readable media of claim 28 wherein the at least one function is related to laboratory ordering and results.

35. The computer readable media of claim 28 wherein the at least one function is related to immunization management.

36. The computer readable media of claim 28 wherein the at least one function is related to physician-to-physician messaging.
